(19) United States
(12) Patent Application Publication
(10) Pub. No.: US 2026/0193038 A1
(43) Pub. Date: Jul. 9, 2026

(54) MULTI-TEMPERATURE STORAGE SYSTEM

(71) Applicant: OCADO INNOVATION LIMITED, Hatfield, Hertfordshire (GB)

(72) Inventors: Andrew INGRAM-TEDD, Hatfield, Hertfordshire (GB); Ian PARKS, Hatfield, Hertfordshire (GB); Paul BIRD, Hatfield, Hertfordshire (GB)

(73) Assignee: OCADO INNOVATION LIMITED, Hatfield, Hertfordshire (GB)

(21) Appl. No.: 18/868,484

(22) PCT Filed: May 22, 2023
(86) PCT No.: PCT/EP2023/063656

§ 371 Date: Nov. 22, 2024

(30) Foreign Application Priority Data
May 23, 2022 (GB) 2207545.1
May 24, 2022 (GB) 2207621.0

(51) Int. Cl. B65G 1/137; B65G 1/04; F25D 13/04; F25D 23/02; F25D 23/06; F25D 25/04

(52) U.S. Cl. CPC B65G 1/1378; B65G 1/0464; B65G 1/0471; F25D 13/04; F25D 23/023; F25D 25/04; F25D 23/063

(57) ABSTRACT

A multi-temperature storage system includes a grid framework structure configured for supporting a robotic load handling device on a track system in a grid pattern of grid cells, and a supporting framework structure for supporting the track system to create a storage space with a storage columns for storage containers. A portion of the storage system is contained within an enclosure having an opening for allowing a robotic load handling device to move into and out of the enclosure. A temperature control system includes an inlet, a temperature control unit for heating or cooling the fluid to a temperature controlled fluid, and an outlet. An air curtain unit recirculates the temperature controlled fluid to provide an air curtain across the opening of the enclosure.

The invention relates to a storage and retrieval system comprising a grid framework structure for handling storage containers or bins stacked in the grid framework structure and one or more robotic load handling devices operable on the grid framework structure, more specifically to a multi-temperature storage system for storage and retrieval of goods and items at different temperatures.

### BACKGROUND

Storage systems 1 comprising a three-dimensional storage grid framework structure, within which storage containers/bins/totes are stacked on top of each other, are well known. PCT Publication No. WO2015/185628A (Ocado) describes a known storage and fulfilment or distribution system in which stacks of bins or containers are arranged within a grid framework structure. The bins or containers are accessed by load handling devices remotely operative on tracks located on the top of the grid framework structure. A system of this type is illustrated schematically in FIGS. 1 to 3 of the accompanying drawings.

As shown in FIGS. 1 and 2, stackable containers, known as storage bins or containers 10, are stacked on top of one another to form stacks 12. The stacks 12 are arranged in a grid framework structure 14 in a warehousing or manufacturing environment. The grid framework structure is made up of a plurality of storage columns or grid columns. FIG. 1 is a schematic perspective view of the grid framework structure 14, and FIG. 2 is a top-down view showing a stack 12 of bins 10 arranged within the grid framework structure 14. Each bin 10 typically holds a plurality of product items (not shown), and the product items within a bin 10 may be identical, or may be of different product types depending on the application.

In detail, the grid framework structure 14 comprises a plurality of vertical uprights or upright members or upright columns 16 that support horizontal grid members 18, 20. A first set of parallel horizontal grid members 18 is arranged perpendicularly to a second set of parallel horizontal grid members 20 to form a grid structure or grid 15 comprising a plurality of grid cells 17. Each grid cell in the grid framework structure has at least one grid column for storage of a stack of containers. For the avoidance of doubt, the term “grid framework structure” is used to mean a three-dimensional structure within which the storage containers are stored, and the terms “grid structure” and “grid” are used interchangeably to mean the two-dimensional structure in a substantially horizontal plane upon which the load handling devices operate. The grid cell has an opening to allow a load handling device to lift a container or storage bin through the grid cell. In the grid structure, the first set of parallel horizontal grid members 18 intersect the second set of parallel horizontal grid members at nodes. The grid structure is supported by the upright members 16 at each of the nodes or at the point where the grid members intersect such that the upright members are interconnected at their tops ends by the intersecting grid members. The grid members 16, 18, 20 are typically manufactured from metal and typically welded or bolted together or a combination of both. The storage bins or containers 10 are stacked between the upright members 16 of the grid framework structure 14, so that the upright members 16 guard against horizontal movement of the stacks 12 of bins 10, and guide vertical movement of the storage bins 10. The top level of the grid framework structure 14 includes rails or tracks 22 arranged in a grid pattern across the top of the stacks 12 to define a track system 4. Referring additionally to FIG. 3, the rails 22 support a plurality of load handling devices 30. The track system comprises a first set 22a of parallel rails 22 to guide movement of the robotic load handling devices 30 in a first direction (for example, an X-direction) across the top of the grid framework structure 14, and a second set 22b of parallel rails 22, arranged perpendicular to the first set 22a, to guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

The track or rail can be a separate component to the grid member (sometime referred to as a ‘track support’) or alternatively, the track is integrated into the grid member as a single body, i.e. forms part of the grid member. For example, each of the first and second sets of horizontal grid members 18, 20 of the grid structure can function as a track support and the first and second sets of tracks of the track system can be mounted to the grid structure for guiding the load handling devices in two dimensions on the grid structure. In the illustrated example, the track is mounted to the horizontal grid members 18, 20, such that the horizontal grid members 18, 20 function as track support members and the grid structure can be defined as a track support structure. In view of this definition, the horizontal grid members 18, 20 are also referred to as track support members, i.e. a first set of track support members extending in the first direction and a second set of track support members extending in the second direction. The track support members form a grid structure or grid 15, which is also referred to as a track support system.

A known load handling device otherwise known as a bot 30 shown in FIGS. 4 and 5 comprising a vehicle body 32 is described in PCT Patent Publication No. WO2015/019055 (Ocado), hereby incorporated by reference, where each load handling device 30 only covers a single grid space or grid cell of the grid framework structure 14. Here, the load handling device 30 comprises a wheel assembly comprising a first set of wheels 34 consisting of a pair of wheels on the front of the vehicle body 32 and a pair of wheels 34 on the back of the vehicle 32 for engaging with the first set of rails or tracks to guide movement of the device in a first direction, and a second set of wheels 36 consisting of a pair of wheels 36 on each side of the vehicle 32 for engaging with the second set of rails or tracks to guide movement of the device in a second direction. Each of the sets of wheels are driven to enable movement of the vehicle in X and Y directions respectively along the rails. One or both sets of wheels can be moved vertically to lift each set of wheels clear of the respective rails, thereby allowing the vehicle to move in the desired direction, e.g. X or Y direction on the grid structure.

The load handling device 30 is equipped with a lifting device or crane mechanism to lift a storage container from above. The crane mechanism comprises a winch tether or cable 38 wound on a spool or reel (not shown) and a grabber device 39 in the form of a lifting frame. The lifting device comprises a set of lifting tethers 38 extending in a vertical direction and connected nearby or at the four corners of the lifting frame 39, otherwise known as the grabber device (one tether near each of the four corners of the grabber device) for releasable connection to a storage container 10. The grabber device 39 is configured to releasably grip the top of a storage container 10 to lift it from a stack of containers in a storage system of the type shown in FIGS. 1 and 2.

The wheels 34, 36 are arranged around the periphery of a cavity or recess, known as a container-receiving recess or container receiving space 41, in the lower part. The recess is sized to accommodate the container 10 when it is lifted by the crane mechanism, as shown in FIG. 5 (a and b). When in the recess, the container is lifted clear of the rails beneath, so that the vehicle can move laterally to a different location. On reaching the target location, for example another stack, an access point in the storage system or a conveyor belt, the bin or container can be lowered from the container receiving portion and released from the grabber device. The container receiving space may comprise a cavity or recess arranged within the vehicle body, e.g. as described in WO 2015/019055 (Ocado Innovation Limited). Alternatively, the vehicle body of the load handling device may comprise a cantilever as taught in WO2019/238702 (Autostore Technology AS) in which case the container receiving space is located below a cantilever of the load handing device. In this case, the grabber device is hoisted by a cantilever such that the grabber device is able to engage and lift a container from a stack into a container receiving space below the cantilever.

To ensure stability of the grid framework structure, prior art storage systems are largely dependent on various supports and bracing arranged within or at least partly along the periphery of the grid framework structure. However, the use of various supports and bracing (anti-movement braces) to stabilise the grid framework structure from internal and external forces is disadvantageous for a number of reasons. The grid framework structure occupies space or area which could be utilised to store containers, in that it prevents optimum usage of available space or area for the storage of containers. The need of a supporting structure may limit the available options for positioning of the grid framework structure since any auxiliary grid supporting structure often requires connection to a surrounding structure such as the inner walls of a building. The requirement of a supporting structure to stabilise the grid framework structure is generally not cost efficient and occupies useful storage space.

WO2019/101367 (Autostore Technology AS) teaches a free-standing storage grid requiring a less extensive auxiliary grid supporting structure by integrating a grid supporting structure in the storage grid structure. The grid supporting structure is made up of four storage columns interconnected by multiple vertically inclined support struts. The storage column profiles have a cross-section comprising a hollow centre section and four corner sections, each corner section comprising two perpendicular bin guiding plates for accommodating a corner of a storage bin. The support struts have a width which allows them to fit in between two parallel guiding plates so as to not compromise the ability of the storage columns to accommodate a stack of containers or storage bins.

To erect the grid framework structure in the art, a plurality of vertical uprights are individually positioned one piece at a time in a grid-like pattern on the ground. The assembling of individual vertical uprights together one piece at a time is sometimes referred to as “stick-built” structures. The “stick-built” approach of the assembling the grid framework structure requires numerous time-consuming adjustments to be made for reliable operation of the robotic load handling devices on the tracks. The height of the vertical uprights and thus the level of the grid mounted thereon is adjusted by one or more adjustable feet at the base or bottom end of each of the vertical uprights. A sub-group of the vertical uprights are braced together to provide structural stability to the grid framework structure. The vertical uprights are interconnected at their top ends by grid members so that the grid members adopt the same grid pattern as the vertical uprights, i.e. the vertical uprights support the grid members at the point or node where each of the grid members intersect in the grid pattern. For the purpose of explanation of the present invention, the points or junctions where the grid members intersect or are interconnected constitute the nodes of the grid structure and correspond to the area where the grid structure is supported by a vertical upright. The resultant grid framework structure can be considered as a free standing rectilinear assemblage of upright columns supporting the grid formed from intersecting horizontal grid members, i.e. a four wall shaped framework.

The arrangement of the vertical uprights provides multiple vertical storage columns for the storage of one or more containers in a stack. The vertical uprights help to guide the grabber device of the lifting mechanism as the grabber device engages with a container within the grid framework structure and is lifted towards the load handling device operative on the grid. The size of the grid framework structure and thus the ability to store containers containing different items or stock keeping units (SKUs) is largely dependent on the number of vertical uprights spanning over a given footprint of the grid framework structure. However, one of the biggest bottlenecks in the building of a fulfilment or distribution centre is the erection of the grid framework structure. The time and cost to assemble the grid framework structure represents a huge proportion of the time and cost to build a fulfilment or distribution centre. The biggest and the most time consuming operation involves erecting the vertical uprights individually and fixing the grid structure to the vertical uprights.

WO2019/157197 (Alert Innovation Inc.) attempts to address this problem by providing an automated fulfilment system comprising a plurality of storage modules, wherein each storage module of the plurality of storage modules comprises a pair of shelf modules comprising a number of defined storage locations for storing containers otherwise known as totes. The pair of shelf modules are spaced apart from each other so as to allow a mobile robot to pass between the pair of shelf modules and retrieve or deliver inventory to storage locations. However, the automated storage system taught in WO2019/157197 (Alert Innovation Inc.) does not provide a dense storage system as taught in WO2015/185628A (Ocado) since the shelf modules takes up valuable storage space.

Storage systems may be used for the storage of goods that require an environment with a controlled temperature, for example chilled or frozen goods. WO2016193419 (Ocado) discloses a storage system comprising one or more heaters and/or one or more chillers for generating temperature controlled gas, one or more fans for circulating the temperature controlled gas through the storage system, and a plenum for receiving the temperature controlled gas. The storage system provides a simple way of regulating the temperature of goods within the storage system.

WO22053372 discloses a grid storage system comprising an under-stack void extending beneath the stacks of storage containers, a plurality of inlets to the under-stack void between the stacks of storage containers, at least one column, which is empty of storage containers and arranged amongst the storage columns, to provide a ventilation column, the ventilation column comprising a fan, wherein a plurality of duct walls surrounding the ventilation column define a duct having a first end adjacent the horizontal rails and a second end adjacent the under-stack void, wherein the fan is arranged to circulate gas along sides of the stacks via the plurality of inlets, the under-stack void and through the duct. The ventilation column can be used to distribute a temperature-controlled gas, hence ensuring an even temperature throughout the storage system.

In some cases, goods at different temperatures are required, for example for chilled goods and ambient temperature goods. Separate storage systems may be provided for goods at different temperatures, for example an ambient storage system for ambient temperature goods and a chilled storage system for chilled goods. Separate storage systems, though able to accommodate different temperature requirements, have the disadvantage of occupying more space than a single storage structure, which is especially a problem for small sites. Small sites are becoming more important as consumer demand for fast fulfillment of orders increases.

In other cases, a single storage system may comprise separate sections for the storage of items at different temperatures within the same grid framework structure. These systems require some kind of insulation or thermal barrier between the sections in order to maintain the temperature difference. The requirement for goods to pass through the thermal barrier causes a pinch point or a limitation in throughput of customer orders.

WO2019001816 (AutoStore) discloses a system comprising at least two different temperature zones arranged horizontally relative to the storage grid, and wherein the storage grid is arranged in at least one of the temperature zones; a thermal barrier dividing the at least two temperature zones, and an elevator for lowering and raising a storage container between an access point accessible from one temperature zone on one side of the thermal barrier and a transfer zone in the storage grid for conveying storage containers between the elevator and a port column of the storage grid accessible to the one or more container handling vehicles within another temperature zone on the other side of the thermal barrier.

Although the above system permits the transfer of containers between different temperature zones, the elevator will be a pinch point or limiting factor on the speed of transfer of goods, and therefore the efficiency of order picking and the efficiency of the system as a whole will be limited.

WO2015124610 (AutoStore) discloses a cooled storage system comprising a grid structure of storage cells. Each cell is arranged to accommodate a vertical stack of storage bins. A remotely operated vehicle is arranged to move at the top level of the grid structure and receive a bin from a storage cell at the top level of the grid structure. Thermal insulation is provided between at least a section of the grid structure and the remotely operated vehicle, and said section of the grid structure has a temperature that is lower than the temperature of the remotely operated vehicle. Insulating covers over the top level of the grid structure are provided, and can be moved by the remotely operated vehicles.

This storage system has the disadvantage that the insulating covers that are needed to prevent heat loss from the grid structure obstruct access to the containers below. In order to retrieve a container, first the thermally insulating cover needs to be moved to another cell in the grid, either by the same vehicle (in which case the operation of the storage system is slowed down), or by a different vehicle (in which case, more vehicles are needed to perform the same operation). In either case, the operation of the storage system is less efficient, and the throughput of customer orders is decreased.

### SUMMARY OF THE INVENTION

The present invention has mitigated the above problem by segregating at least a portion of a storage and retrieval system by an enclosure for the storage of items or goods at a different temperature, e.g. grocery items. The enclosure has an opening to allow a robotic load handling device operable in the storage and retrieval system to move between the enclosure and outside of the enclosure. The enclosure can be connected to a chiller system so as to maintain the temperature inside the enclosure at a lower temperature than the temperature externally or outside of the enclosure. For example, the chiller system can maintain the temperature inside the enclosure to provide a chilled zone, e.g. in the temperature range of 4° C. to 8° C. Equally, the chiller system can maintain the temperature inside the enclosure to provide a freezer zone, e.g. in the temperature range −18° C. to −22° C. Equally, the enclosure can be connected to a heating system so as to maintain the temperature inside the enclosure above the temperature externally or outside of the enclosure. The enclosure can be thermally insulating to reduce the transfer of heat into and/or out of the enclosure.

To prevent or substantially reduce the transfer of heat into the opening of the enclosure, the present invention provides at least one air curtain unit providing an air curtain across the opening. The at least one air curtain unit uses a fan to force a curtain of air in a downward direction and across the opening. The forced air creates an invisible barrier that helps to control temperatures by preventing hot or cold air from entering the enclosure at the opening. The air curtain is advantageous over having a physical door to enter the enclosure, as a physical door would create a bottleneck on the grid framework structure as one or more robotic load handling devices would have to be waiting to enter and exit the enclosure via the physical door in order to retrieve and/or deposit items or goods that are stored at the different temperature.

In order to meet demand for items or goods stored at different temperatures, traditionally, storage and retrieval system for storing items or goods at the different temperatures are housed in separate temperature-controlled rooms or buildings. The separate rooms have their own dedicated grid framework structure for storage of storage containers in stacks and one or more robotic load handling devices operable on the grid framework structure to store and/or retrieve the storage containers. The separate room allows the temperature inside the room to be controlled, e.g. via a separate cooling facility. This arrangement allows one or more robotic load handling devices operable on their respective grid framework structures to operate at their optimum capacity.

However, the problem with this arrangement is that there may be over capacity in one or more storage and retrieval systems holding items or goods at the different temperatures. The problem is exacerbated as a result of different seasonal events such as summer and winter months where the demand for chilled items may outstrip the demand for warmer items. This inefficiency of the storage and retrieval of items become more profound when trying to cater for a market where there is a demand for convenience items or goods. This is particularly the case where the order comprises a small number of generally staple items, e.g. bread or milk, and can also include the impulsive buying behaviour of customers who have a tendency to buy goods without planning in advance. When a customer takes such buying decisions on the spur of the moment, it is usually triggered by emotions and feelings, i.e. making an unplanned purchase. Typically, convenience stores that stock a wide range of everyday items such as coffee, groceries, snack foods, confectionery, soft drinks, tobacco products, over-the-counter drugs, toiletries, newspapers, and magazines tend to be best placed to cater for such an impulsive market. With the market for convenience stores and impulsive purchase increasing, a storage and retrieval system is thus required that can address the above problems. A storage and retrieval system is thus required where goods or items stored at different temperatures can be stored and/or retrieved from a single storage and retrieval system.

The present invention provides a multi-temperature storage system comprising:
A) a grid framework structure configured for supporting a robotic load handling device thereupon, said grid framework structure comprising:
   i) a track system comprising a plurality of tracks arranged in a grid pattern comprising a plurality of grid cells,
   ii) a supporting framework structure for supporting the track system above the ground to create a storage space comprising a plurality of storage columns, each storage column being arranged to store a stack of storage containers, such that, in use, the robotic load handling device operative on the track system is able to lift one or more containers through a grid cell from a stack in a storage column,
wherein a portion of the storage system is contained within an enclosure, said enclosure having an opening above the track system for allowing a robotic load handling device to move into and out of the enclosure;
B) a temperature control system comprising an inlet for drawing a fluid from the enclosure, a temperature control unit for heating or cooling the fluid to a temperature controlled fluid, and an outlet for providing the temperature controlled fluid into the enclosure such that the enclosure has a different temperature than the temperature external of the enclosure;
C) at least one air curtain unit arranged above the track system, said at least one air curtain unit being arranged to recirculate the temperature controlled fluid from the enclosure to provide an air curtain across the opening of the enclosure so as to substantially contain the temperature controlled fluid within the enclosure and enable the robotic load handling device to move on the track system into and out of the enclosure.

For the purpose of definition, the term “fluid” is broadly construed to include air but can include other fluids, e.g. other gases. The term “air curtain” should not be interpreted as limiting the fluid to air. Not only does the air curtain help to contain the temperature controlled fluid within the enclosure but more importantly allow one or more robotic load handling devices to move in and out of the enclosure with ease since the air curtain does not present a physical barrier for movement of the one or more robotic load handling devices through the opening of the enclosure. This in turn allows one of the robotic load handling devices to retrieve one or more storage containers from inside the enclosure and move the storage containers to a location outside of the enclosure, e.g. in the ambient region. As a result, different temperature regions can co-exist in a single storage and retrieval system as they share the same track system and thus, robotic load handling devices operating on the track system.

Optionally, the multi-temperature storage system comprises a robotic load handling device comprising:
a) a wheel assembly for guiding the load handling device on the track system;
b) a container-receiving space located above the track system; and
c) a lifting device arranged to lift a storage container from a stack into the container-receiving space.

Optionally, the temperature control system comprises a chiller system and the temperature control unit comprises a chiller unit such that the temperature within the enclosure is lower than the temperature external of the enclosure. Optionally, the temperature control system comprises a heating system and the temperature control unit comprises a heating unit, e.g. electrical heating elements, such that the temperature within the enclosure is higher than the temperature external of the enclosure. The provision of a heating system connected to the enclosure allows the storage system to store items or goods at an elevated temperature to the ambient temperature, e.g. hot foods.

The ability to share load handling devices between different temperature regions helps to smooth out variations in demand for ambient and chilled products. If there is a sudden surge in demand for chilled products (for example, customers impulse-buying ice cream for a particularly sunny bank holiday weekend), load handling devices from the ambient temperature region of the storage system outside the enclosure can be redeployed to the chilled temperature region inside the enclosure, thus increasing the capacity and throughput of customer orders. Similarly, if the customer demand for chilled goods is lower and the demand for ambient goods is higher, load handling devices in the chilled temperature region of the storage system can be redeployed into the ambient temperature region to increase the capacity and throughput of customer orders. The air curtain enables this redistribution of load handling devices because the track system is shared between the different temperature regions so a load handling device can simply pass through the air curtain when required.

Preferably, the at least one air curtain unit has an air intake extending into the enclosure and an outlet comprising a nozzle configured for directing the temperature controlled fluid downwardly into the enclosure. As the temperature controlled fluid (e.g. air) for generating the air curtain is recirculated from the temperature controlled fluid in the enclosure and where the temperature controlled fluid is cooled to a temperature for storing items or goods in a chilled environment, it is important that the air curtain does not impinge on storage containers outside of the enclosure that store items or goods in an ambient environment for fear of spoiling those items or goods. Optionally, the nozzle is configured for directing the temperature controlled fluid in a downwardly inclined direction towards the enclosure (e.g. at a small angle from the vertical). For example, the nozzle can comprise one or more moveable baffles that control the direction of flow of the air curtain.

Optionally, the opening of the enclosure extends across at least one direction of the grid framework structure such that the at least one air curtain unit is configured for providing an air curtain across the at least one direction of the grid framework structure, i.e. across multiple grid cells of the track system. For example, the at least one direction across the grid framework structure can be across the grid framework structure in a first direction and/or second direction, the second direction being perpendicular to the first direction. Depending on the size of the opening of the enclosure, optionally, the at least one air curtain unit comprises a plurality of air curtain units arranged side-by-side. To provide an air curtain that can extend across multiple grid cells across the track system, multiple air curtain units can be arranged side-by-side. To reduce or remove any gaps between the air curtains from adjacent air curtain units, the edges of adjacent air curtains can partially overlap.

Whilst the air curtain provides an invisible barrier to prevent the flow of heat into the enclosure, optionally, the enclosure is thermally insulating so as to reduce or prevent the transfer of heat through the walls of the enclosure. Optionally, the enclosure has a lower portion below the track system and an upper portion above the track system, the lower portion of the enclosure comprising thermal insulating solid walled panels. For the thermal insulating solid walled panels to be a load bearing wall within the grid framework structure, optionally, one or more of the thermal insulating solid walled panels comprises a structural insulation panel comprising a thermal insulation core sandwiched between at least two layers of structural board. The at least two layers of structural board can comprise magnesium oxide.

To provide thermal insulation in the upper portion of the enclosure above the track system, optionally the enclosure comprises a hood providing coverage for the upper portion of the enclosure. Optionally, the upper portion of the enclosure comprises a thermally insulating cover having a top wall and downwardly extending sidewalls, e.g. opposing sidewalls. Preferably, at least one of the downwardly extending sidewalls comprises the opening. Optionally, the thermally insulating cover comprises a thermally insulating blanket. The advantage of using a thermally insulating blanket to provide thermal insulation in the upper portion of the enclosure is that the thermal insulating blanket is flexible, suitable for the inlet and/or the outlet of the temperature control system to extend through the thermally insulating cover.

To provide an air curtain across the opening of the enclosure, preferably, the at least one air curtain unit is mounted adjacent the opening. Optionally, the temperature control system comprises one or more ducts extending from the inlet to the outlet via the temperature control unit so as to circulate the temperature controlled fluid from the temperature control unit into the enclosure via the outlet. Optionally, the temperature control system comprises one or more fans for drawing the fluid from the enclosure via the inlet. To distribute the temperature controlled fluid into the interior space of the enclosure, optionally, the outlet comprises at least one diffuser.

Optionally, the multi-temperature storage system further comprises at least one inventory handling station arranged below the track system and one or more of the grid cells of the track system defines a port for delivering and picking up a storage container to and from the inventory handling station. One of the advantages of using the same track system that extends through the different temperature regions of the storage system by the use of an enclosure with an opening that has an invisible insulating barrier provided by the air curtain so that the track system can extend through the opening is that different temperature regions of the storage system can share the same inventory handling station. In other words, the same inventory handling station can be used to fulfil customer orders with items or goods stored in the enclosure, e.g. chilled items, as well as items or goods stored outside of the enclosure, e.g. ambient items. Thus, a robotic load handling device operable on the track system extending through the opening of the enclosure can retrieve a storage container from inside the enclosure and move the storage container to the inventory handling station outside of the enclosure. Equally, a robotic load handling device operable on the track system outside of the enclosure can retrieve a storage container in storage outside of the enclosure and move the storage container to the same inventory handling station. The inventory handling station can be a pick station and/or a stocking station. Since the air space within the enclosure can be chilled for the storage of chilled items or goods, ideally, the inventory handling station is located under the track system outside of the enclosure, e.g. in the ambient environment. This allows personnel at the inventory handling station to be working in a more comfortable working environment.

Typically, a separate area is provided by incorporating a mezzanine supported by vertical beams in amongst adjacent grid framework structures and is generally a standalone structure. The mezzanine provides a tunnel to accommodate, for example, one or more inventory handling stations. However, the problem with this arrangement is that no two grid framework structures are the same size, and the size and layout of the grid framework structure largely depends on the footprint of the building or distribution centre to which grid framework structure is housed. The incorporation of the mezzanine within the grid framework structure would add another layer of complexity to the grid framework structure removing any flexibility in the design of the storage and retrieval system comprising the grid framework structure and the inventory handling station.

In a move towards increasing the modularity of the storage system, instead of incorporating a mezzanine within the grid framework structure, optionally, the multi-temperature storage system further comprises a second supporting framework structure and a support platform for supporting the second supporting framework structure. Said support platform is raised above the ground by a plurality of legs so as to define an area under the support platform for accommodating the inventory handling station. The support platform provides a separate area under the support platform for accommodating the inventory handling station. The support platform can be offered up to the supporting framework structure so as to provide an area below the support platform for accommodating the inventory handling station. Optionally, the second supporting framework structure is arranged below the track system such that the track system extends continuously across the supporting framework structure and the second supporting framework structure. The support platform can used to emulate a mezzanine in the grid framework structure such that a plurality of stacks of storage containers can be stored in storage columns above the support platform; the storage columns above the support platform being provided by the second supporting framework structure. Thus, in use, a robotic load handling device operable on the track system can move from an area in the enclosure to an area above the inventory handling station, where a storage container retrieved by the robotic load handling device can be dropped off to the inventory handling station via a delivery port in the track system.

Whilst the supporting framework structure can comprise a plurality of upright columns or uprights to form a plurality of storage columns for the storage of a plurality of storage containers in stacks as discussed above in the introductory part of the patent specification, to increase the modularity of the storage system, optionally, the supporting framework structure can comprise a plurality of prefabricated modular panels, said prefabricated modular panels being arranged in a three dimensional grid pattern comprising a first set of parallel prefabricated modular panels extending in the first direction and a second set of parallel prefabricated modular panels extending in the second direction to define a plurality of grid cells.

To achieve a three dimensional grid pattern of the supporting framework structure, each of the prefabricated modular components is planar-hence, the prefabricated modular components can also be known as prefabricated modular panels. Building the supporting framework structure from prefabricated modular panels is different to the “stick-built” approach. In the “stick-built” method of constructing the supporting framework structure, individual vertical uprights are first erected one at a time to form multiple storage columns for storing a plurality of storage containers in a stack. The track system is mounted to the plurality of vertical uprights by interconnecting the upper ends of the vertical uprights by a plurality of intersecting track support members in a grid pattern forming the track support structure comprising a plurality of grid cells or grid spaces. Alternatively, the supporting framework structure can be formed from a plurality of prefabricated modular panels that are arranged in a three dimensional grid pattern comprising a plurality of grid cells. Each of the plurality of grid cells provided by the three dimensional grid pattern defines a storage space for storing one or more stacks of storage containers.

The prefabricated modular panels are load bearing in the sense that, when assembled together to form the supporting framework structure, they provide a load bearing structure to support one or more load handling devices moving on the track system mounted to the supporting framework structure.

The use of prefabricated modular panels to erect the grid framework structure allows the grid framework structure to be assembled at a much faster rate than the traditional ‘stick-built’ approach where individual vertical uprights are initially erected one by one on the floor and the track support members mounted to the upper end of the vertical uprights. The modular construction of the supporting framework structure and each of the prefabricated modular panels extending in a single plane also facilitates the ability to flat pack the supporting framework structure for transport. The prefabrication of the modular panels permits quick assembly of the supporting framework structure at a site or within a building. This has the advantage that the supporting framework structure can be constructed in existing vacant buildings or warehouses.

Since each of the grid cells of the supporting framework structure defines a storage space for storing one or more stacks of storage containers, preferably the grid pattern arrangement of the prefabricated modular panels is such that each of the grid cells of the supporting framework structure is sized to support a subset of the plurality of grid cells of the track system, said subset comprising two or more grid cells of the track system. Each of the grid cells of the supporting framework structure therefore functions as a storage column for the storage of two or more stacks of storage containers. This permits a robotic handling device operative on the track system to position itself over a grid cell of the track system and retrieve or lower a storage container from a stack stored within a storage column of the supporting framework structure.

Optionally, one or more of the plurality of prefabricated modular panels comprises a prefabricated braced frame, said prefabricated braced frame comprising a plurality of parallel uprights extending in a common vertical plane and connected together by one or more bracing members lying in the common vertical plane of the plurality of parallel uprights. Each of the prefabricated braced frames can be envisaged as panel frames such that the supporting framework structure is formed from an assembly of panel frames. The braced panel frames when assembled together in a three dimensional grid array form a stable three dimensional grid framework structure. The structural integrity of the three dimensional supporting framework structure enables one or more crash barriers to be mounted directly onto the support framework structure rather than on a separate support structure. Since the thermal insulating solid walled panels can be load bearing, e.g. comprising a structural insulation panel, optionally, at least one of the plurality of prefabricated modular panels can comprise at least one of the thermal insulating solid walled panels.

Optionally, the grid framework structure further comprises a track support structure lying in a horizontal plane and being supported by the supporting framework structure, said track support structure comprising a first set of parallel track support members extending in a first direction and a second set of parallel track support members extending in a second direction, the second direction being substantially perpendicular to the first direction such that the first and second sets of parallel track support members are arranged in a grid pattern comprising a plurality of grid cells or grid spaces. The track system is mounted to the track support structure such that the grid cells of the track system correspond to the grid cells of the track support structure.

In addition to prefabricating the supporting framework structure from a plurality of modular panels so as to facilitate easy transport and assembly of the supporting framework structure, the track support structure can also be modularised so as to enable the track support structure to be flat packed to facilitate easy transport and assembly. Optionally, the track support structure comprises a plurality of prefabricated modular sub-track support structures that are assembled together to form the track support structure, each of the plurality of prefabricated modular sub-track support structures comprising two or more grid cells. Preferably, each of the prefabricated modular sub-track support structures comprises a portion of the first set of track support members extending in the first direction and a portion of the second set of track support members extending in the second direction.

Typically, multiple rail or track sections are necessary to build the track or rail. The greater the number of rail or track sections necessary to build the track, the more complicated is the assembly of the track system. In a majority of cases, there is a two to one relationship between the number of rail or track sections or segments at each of the nodes or the intersections of the track support members in the track support structure, in the sense that more than one rail or track sections are connected together at each node of the track support structure. For example, in WO2018/146304 (Autostore Technology AS), when making the intersections between the first and second sets of rails or tracks, the second set of rails or tracks all comprise a recess into which the first set of rails or tracks may be arranged.

Additionally, to provide a plurality of rectangular or square shaped grid cells, multiple different sized track or rail sections are connected together in the track system. For example, for each grid cell there is a rail or track section extending in one direction of one length and another track or rail section extending in a second direction of a different length. The different lengths of the rail or track sections meet at a node in the track system where they intersect. The need to have different lengths of rail or track sections complicates the assembly of the track or rail sections in a grid pattern. A track or rail is thus required that uses of a small number of rail or track sections when assembling the track system.

Optionally, the track system comprises a plurality of interconnected modular track sections, each track section of the plurality of interconnected modular track sections comprising substantially perpendicular elements so as to provide a track surface extending in the first direction and a track surface in the second direction. In other words, each of the plurality of track sections can be cross shaped, having a first track section element extending in the first direction and a second track section element intersecting with the first track section element and extending in the second direction. By having a track system whereby each track section of the plurality of track sections is formed as an unitary or single body so as to provide a track surface or path extending in transverse directions, the number of track sections necessary to build the track is reduced in comparison to prior art track systems-thereby simplifying the layout of the track sections on the track support structure. For example, a one to one relationship can exist between each of the plurality of track sections and each single node in the track support structure, in the sense that only a single track section is required at each of the nodes of the track support structure. A ‘node’ in the track support structure is the point where the first and second sets of parallel track support members intersect in the grid pattern. In prior art track systems, there is a two to one relationship between the number of track sections and a single node in the track support structure in the sense they have one track section extending in the first direction and another separate track section extending in the second direction.

Ideally, the surface of the track system mounted to the grid structure is continuous and substantially smooth to prevent the undesirable up and down bumping impact to the wheels of the load handling device travelling on the track system. It is believed that the areas of the track system that are most vulnerable to cause this up and down bumping of the wheels of the load handling device are where the track sections meet at the nodes in the track system. This is the area of the track system where the track support members intersect or converge.

Generally in the art, to ensure that the track system is level and to compensate for an uneven floor, the level of the track support structure mounted to vertical uprights is adjusted by having an adjustable levelling foot at the base or lower end of the vertical uprights comprising a threaded shaft that can be extended or retracted relative to the base of the vertical upright. The requirement to adjusting the level of the track support structure can be partially attributable to the vertical displacement of the interconnected track support members where they intersect at the top ends of the vertical uprights, i.e. at the nodes of the track support structure.

In prior art track systems, as one or more track sections mounted on the track support members meet at the nodes of the track system, such vertical displacement of the underlying track support members at the nodes creates an undesirable edge or step that is transferred to the track sections mounted thereon, which in turn is susceptible to being struck by the wheels of the load handling devices as they travel on the tracks.

The problem of misalignment of the track support members at the junction where the track support members meet at the nodes may be exacerbated when the supporting framework structure is assembled from the plurality of prefabricated braced frames as defined in the present invention. As the plurality of the prefabricated braced frames are assembled together by connecting one of the plurality of uprights of the prefabricated braced frames with one of the plurality of uprights of an adjacent prefabricated braced frame, the junction where the uprights of adjacent prefabricated braced frames join or meet are susceptible to misalignment. This may result in misalignment in the junction or connection between adjacent prefabricated modular sub-grid structures on the supporting framework structure, leaving a physical step or bump which is translated to the overlying track system.

The present applicant has realised that devising a track section element that covers areas of the track support structure that are most vulnerable to this variation in height displacement of the track support members, namely at the nodes of the track support structure, mitigates the up and down bumping impact of the wheels of the load handling devices as they travel on the track/grid structure. In other words, the track section of the present invention masks any imperfections or edges in the underlying track support members which largely occur at the nodes where the track support members intersect or converge together and transfers the joint where adjacent track sections meet to the areas of the track support structure that are less susceptible to such height variations. The areas of the track support structure that are less susceptible to such height variations as a result of adjoining track support members are along the length of the track support members, more specifically between or intermediate of adjacent or neighbouring nodes of the track support structure. Preferably, the plurality of track sections are assembled in the track system such that adjacent modular track sections in the track system meet between the areas of the track support structure where the first and second sets of track support members intersect or converge in the grid pattern.

To further mitigate the up and down bumping of the wheels of the robotic load handling device, preferably, the plurality of track sections are connected by a joint comprising tapered edges. For the purpose of the present invention, the term “joint” is broadly construed to mean abutting ends of adjacent track sections. The meeting ends of adjacent track sections are cut or shaped in such a way that they are mitred together. Preferably, the plurality of track sections are connected by a joint comprising tapered edges. Before the wheels of the load handling device roll over the edge of a track section element completely, part of the wheel has already touched the mitred edge of the track section element of an adjacent track section. This provides a gradual transition of the track joint and prevents a greater portion of the wheel from striking an edge of the joint further mitigating this up and down bumping impact, reducing any noise and vibration of the wheels of the load handling device in comparison to a joint cut at right angles to the direction of travel of the load handling devices on the track. Optionally, each of the plurality of interconnected modular track sections is formed from a plastic material. The use of plastic material to fabricate the track sections allows the track sections to be fabricated to tighter tolerances that can be achieved by extrusion alone. The use of plastic material to fabricate the track section of the present invention, allows the track sections to be injection moulded. Unlike extrusion, injection moulding allows parts to be formed to very tight tolerances removing or mitigating the need to carry out excessive machining on the finished parts. In addition, injection moulding allows one or more profiles to be incorporated to the track in precise or intricate detail, which is essential to guide the wheels of the load handling device on the track without the possibility of derailing.

To prevent a grabber device of the robotic load handling device and any storage container attached thereto from swinging when being lifted through a grid cell of the track system, the grid framework structure further comprises a plurality of guides extending vertically between the grid structure and the floor. The plurality of guides are arranged in a pattern for accommodating a plurality of storage containers in stacks between the plurality of guides and to guide the plurality of storage containers through a grid cell. Unlike the vertical uprights of the prefabricated modular panels, which are largely load bearing, the guides are intended to guide the grabber device and/or storage container through a grid cell of the track system. Removal of the load bearing function of the guides allows the guides to provide some give when guiding a storage container through a grid cell of the track system. Traditionally, the vertical uprights have a load bearing function to support the track system as well as to guide the storage containers through a grid cell. However, in an event that the storage container is not properly orientated when being lifted, in the sense that one or more corners of the storage container has dropped due to the different lengths of the lifting tethers suspending the grabber device from the body of the robotic load handling device, there is the risk that the storage container may get jammed or stuck between the vertical uprights due to the stiffness of the vertical uprights supporting the track system. By removal of this load bearing capacity, the guides can made more flexible offering a degree of resiliency so as to provide some give should a storage container foul the guides. This resiliency allows the guides to deflect to accommodate any improper orientation of the storage container when being lifted or lowered through the grid framework structure. The resiliency of the guides is such as to be sufficiently stiff to properly guide the storage containers through the grid cells but not too stiff so as to offer some give to prevent a storage container being stuck or jammed between the guides.

Preferably, each guide of the plurality of guides comprises two perpendicular bin guiding plates extending between the grid structure and the floor for accommodating a corner of a storage container. The two perpendicular bin guiding plates are configured to accommodate a corner section of a grabber device and/or storage container. Thus, four guides would be necessary to accommodate the four corner sections of a standard storage container, which is generally rectilinear in shape.

To provide a lightweight and high strength metal guide, optionally, at least a portion of the two perpendicular bin guiding plates is textured formed by continuous cold rolling a pattern into the two perpendicular plates. The incorporation of a textured pattern into the guide improves the structural integrity of the guides. One example of a lightweight steel formed by the cold rolling process is ultraSTEEL® from Hadley Group, United Kingdom. Optionally, the texture comprises dimples or indentations. To reduce the friction between the grabber device of the robotic load handling device and/or storage container and the surface of the guide, optionally, each guide of the plurality of guides comprises a running surface for engaging with a grabber device of the robotic load handling device, and wherein the running surface is substantially smooth. The use of a textured cold rolled steel is not limited to the guides and can be used in the fabrication of any part of the support framework structure. For example, the prefabricated modular panels can be fabricated from a cold rolled forming process, e.g. the use of ultraSTEEL®.

Optionally, the plurality of guides comprises four guides, said four guides being symmetrically arranged about a centre point defined by the four guides such that the four guides are arranged for guiding the corners of four adjacent storage containers. The centre point can be the cap plate that is used to secure the plurality of guides together such that the plurality of guides can be arranged around the cap plate.

Whilst it is not necessary to engage or accommodate all four corners of a storage container along the guides as the container is hoisted towards the grid structure by the lifting mechanism of the load handling device, in another embodiment of the present invention, the plurality of guides are arranged for guiding one or more containers in a stack along only a pair of diagonally opposed corners of the one or more containers. This gives the grabber device and/or the storage containers a level of lateral stability in the X and Y direction as the storage container is hoisted along diagonally opposed guides. By guiding the grabber device and/or the storage container attached thereto by only diagonally opposed guides, the number of guides necessary to guide the grabber device and/or the storage container attached thereto is reduced. In fact, the plurality of guides can be arranged at alternate nodes in the first direction (e.g. x direction) and in the second direction (e.g. y direction) such that the one or more containers are stacked between two guides at only the diagonally opposed corners of the storage containers.

In a further aspect of the present invention, the enclosure comprises a plurality of enclosures for enclosing a respective portion of the storage system such that each enclosure of the plurality of enclosures comprises:
i) a respective opening for allowing a robotic load handling device to move into and out of the respective enclosure,
ii) a respective temperature control system comprising a respective inlet for drawing a fluid from the respective enclosure, a respective temperature control unit for cooling the fluid to a temperature controlled fluid, and a respective outlet for providing the temperature controlled fluid into the respective enclosure such that the respective enclosure has a lower temperature than the temperature external of the respective enclosure;
iii) at least one respective air curtain unit arranged above the track system, said at least one respective air curtain unit being arranged to recirculate the temperature controlled fluid from the respective enclosure to provide a respective air curtain across the opening of the respective enclosure so as to substantially contain the temperature controlled fluid within the respective enclosure and enable the robotic load handling device to move on the track system into and out of the respective enclosure.

By enclosing different proportions of the storage system by a plurality of enclosures, each enclosure of the plurality of enclosures having its own dedicated temperature control system, e.g. chiller system or heating system, such that the plurality of enclosures shares a common track system, the storage system according to the present invention is able to store different temperature sensitive items, e.g. chilled and/or frozen items and/or heated items. For example, a first enclosure can be configured to store items at the chilled temperature and a second enclosure can be configured to store items at the frozen temperature. The respective air curtains of the plurality of enclosures provide an invisible insulation to enable one or more robotic load handling devices to enter and exit the respective enclosures. Depending on the items required to fulfil one or more customer orders, one or more robotic load handling devices operable on the track system are able to visit one or more of the plurality of enclosures to retrieve one or more storage containers from their respective enclosures and deliver the one or more storage containers to an inventory handling station. Since the plurality of enclosures share a common inventory handling station, a greater proportion of customer orders comprising different temperature sensitive items can be fulfilled by a single storage system. The storage system can comprise a plurality of inventory handling stations to fulfil multiple customer orders.

Optionally, the enclosure can have two or more openings such at a robotic load handling device is able to enter the enclosure at one end of the enclosure and exit the enclosure through another end of the enclosure, e.g. configured as a tunnel. Each of the two or more openings of the enclosures may have its own dedicated air curtain to provide an invisible insulation barrier to contain the temperature controlled fluid within the enclosure.

### BRIEF DESCRIPTION OF FIGURES

Further features and aspects of the present invention will be apparent from the following detailed description of an illustrative embodiment made with reference to the drawings, in which:

FIG. 1 is a schematic diagram of a grid framework structure according to a known system.

FIG. 2 is a schematic diagram of a top down view showing a stack of bins arranged within the supporting framework structure of FIG. 1.

FIG. 3 is a schematic diagram of a known storage system of a load handling device operating on the grid framework structure.

FIG. 4 is a schematic perspective view of the load handling device showing the lifting device gripping a container from above.

FIG. 5(a) and 5(b) are schematic perspective cut away views of the load handling device of

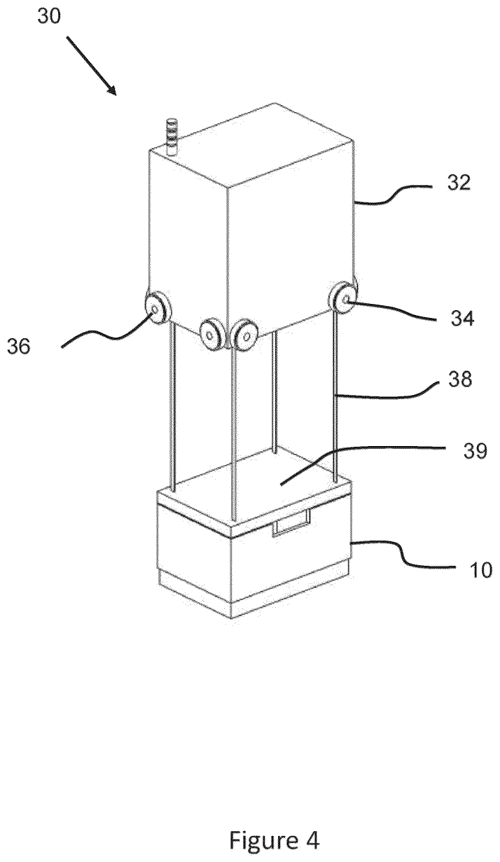

FIG. 4 showing (a) a container accommodated within the container receiving space of the load handling device and (b) the container receiving space of the load handling device.

FIG. 6 is a schematic perspective view of a multi-temperature storage system according to the invention.

FIG. 7 is a flowchart illustrating the flow of fluid in the storage system.

FIG. 8 is a perspective cross-sectional view of the enclosure of the multi-temperature storage system.

FIG. 9 is a schematic view of a load handling device passing through an air curtain.

FIG. 10 is a schematic view of an air curtain unit.

FIG. 11 is a perspective view of the supporting framework structure according to the present invention.

FIG. 12 is a perspective view of cladding at least one exterior wall of the supporting framework structure according to the present invention.

FIG. 13 is a perspective view showing a top plan view of the grid cells of the track system nested with each of the grid cells of the supporting framework structure.

FIG. 14 is a perspective view showing the mounting of the track sections to the track support or the grid members of the grid structure according to the present invention.

FIG. 15 is a side view of the enclosure of the multi-temperature storage system with a platform and pick station.

FIG. 16 is a perspective view of the enclosure of the multi-temperature storage system with a platform and pick station.

FIG. 17 is a plan view of a guide with bin guiding plates incorporating a textured pattern.

### DETAILED DESCRIPTION

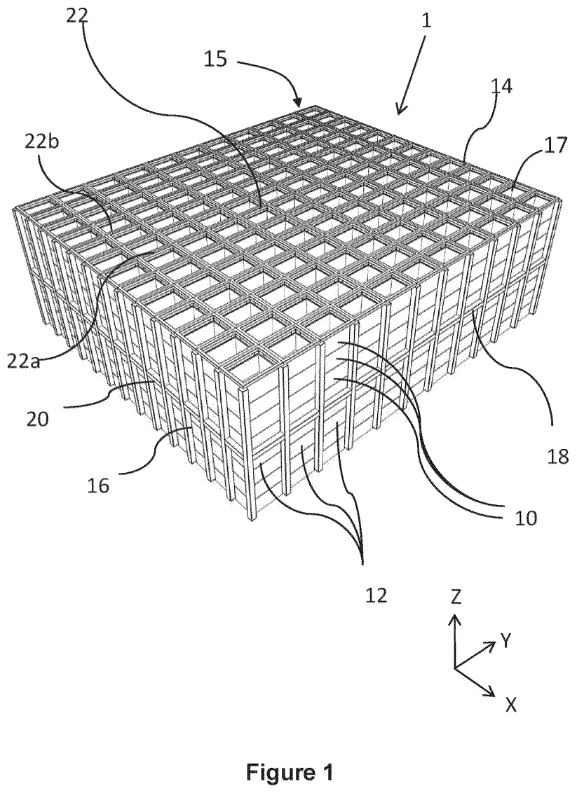

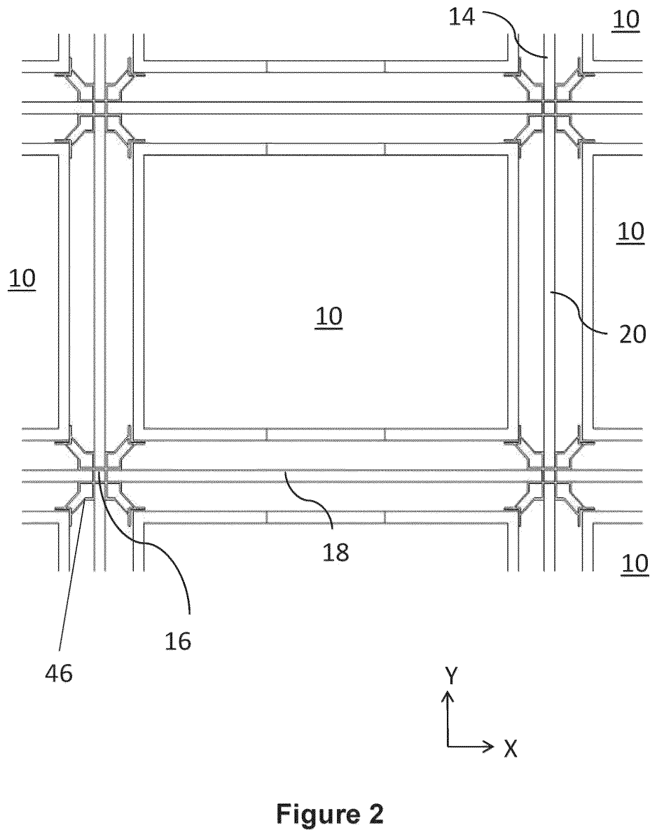

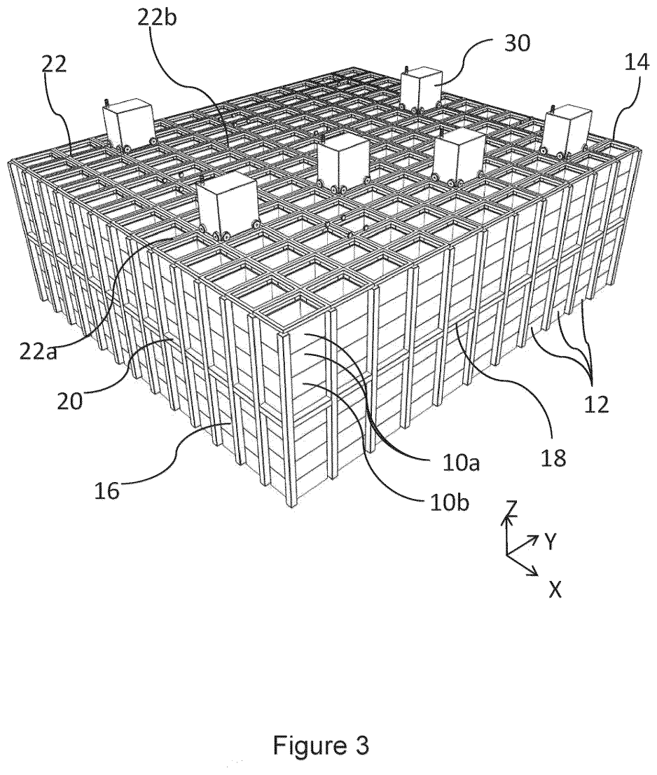

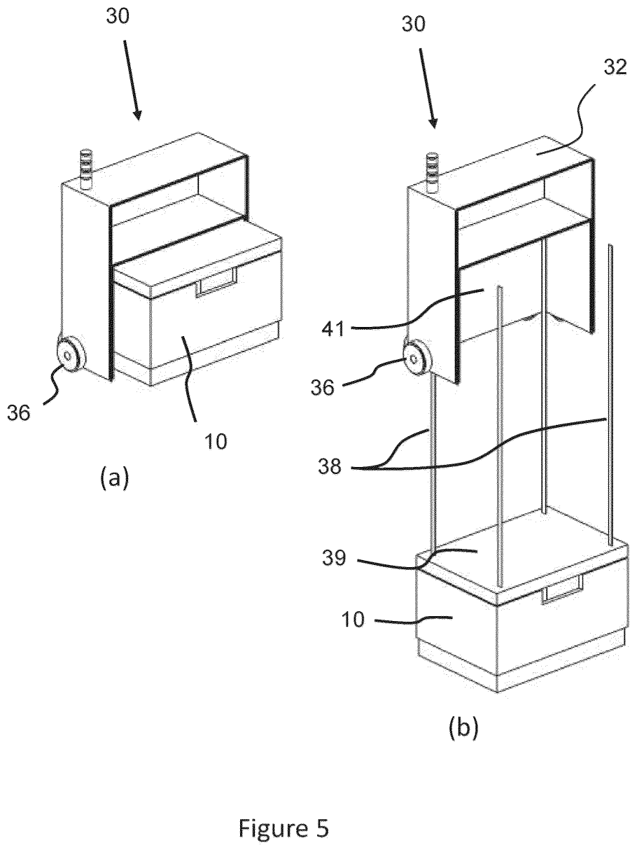

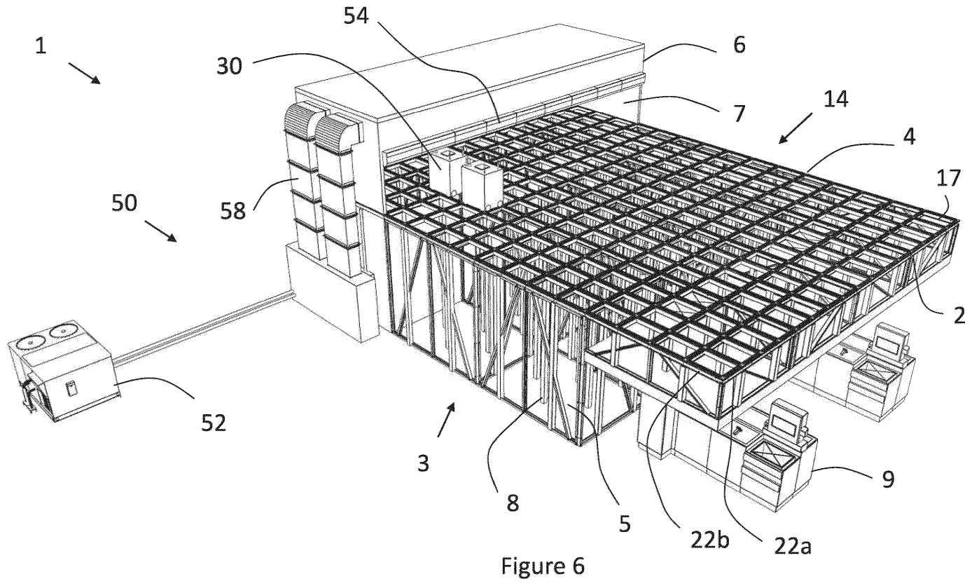

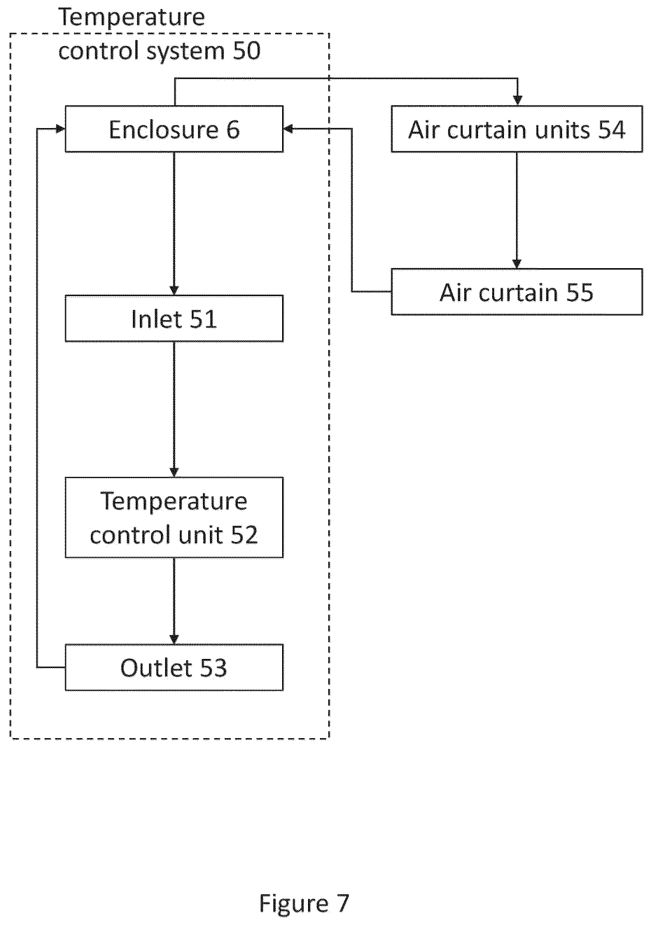

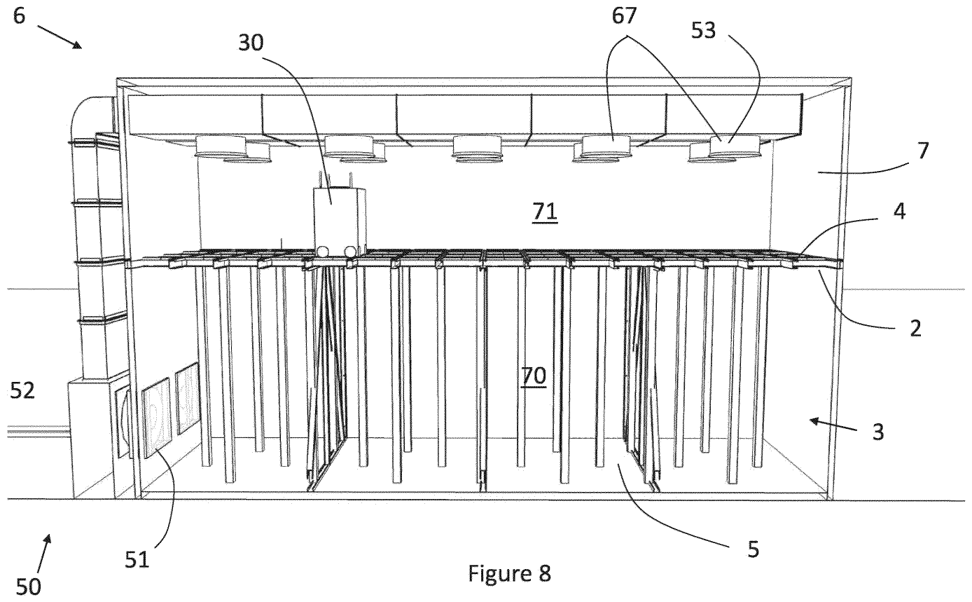

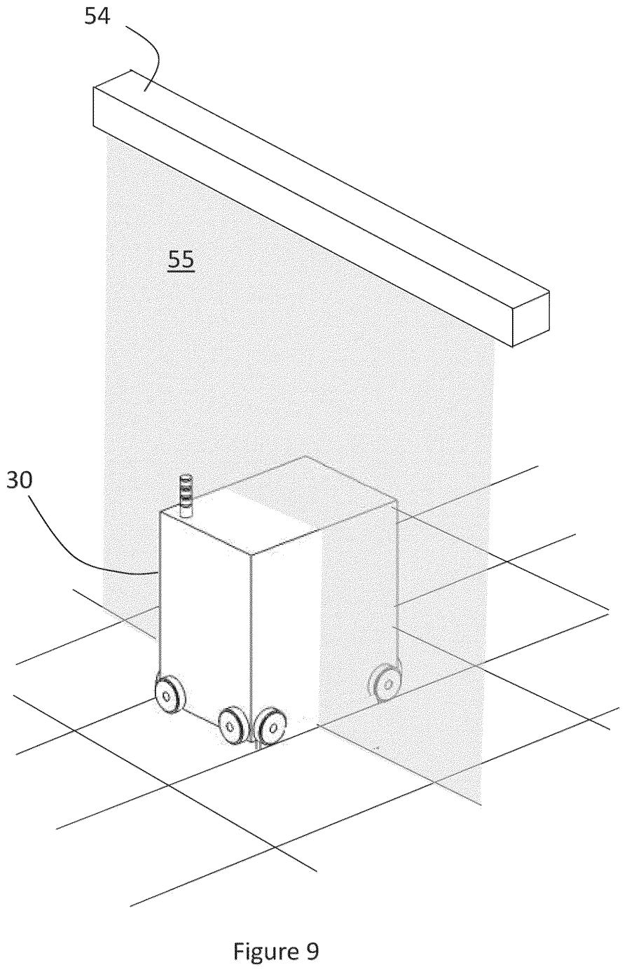

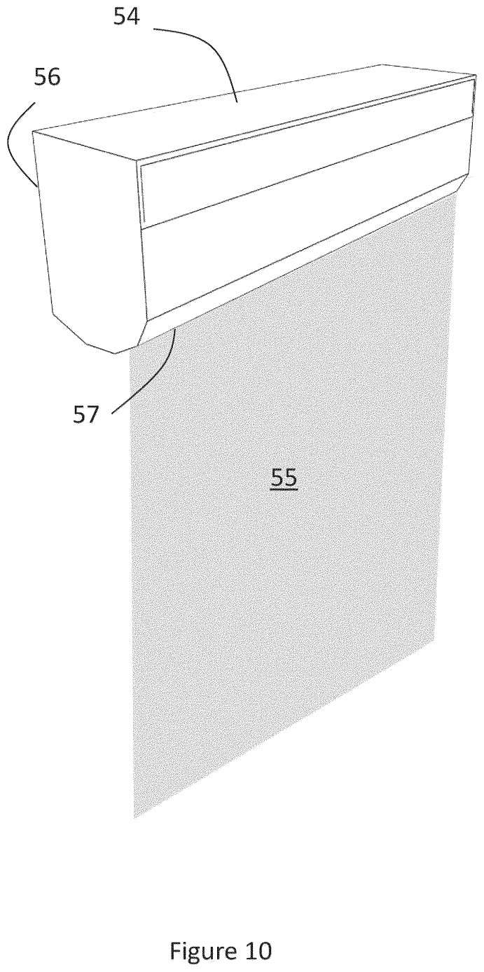

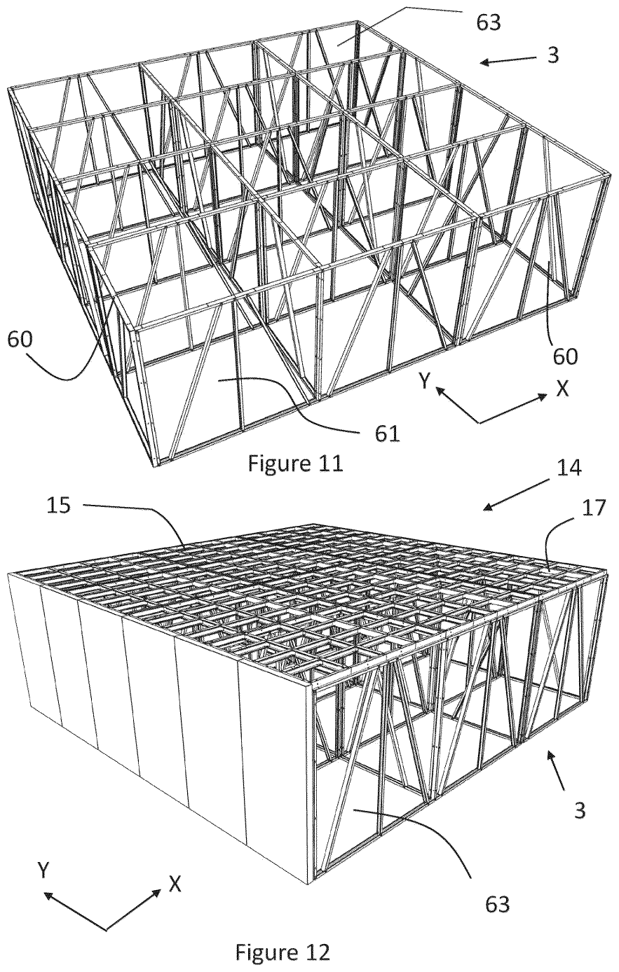

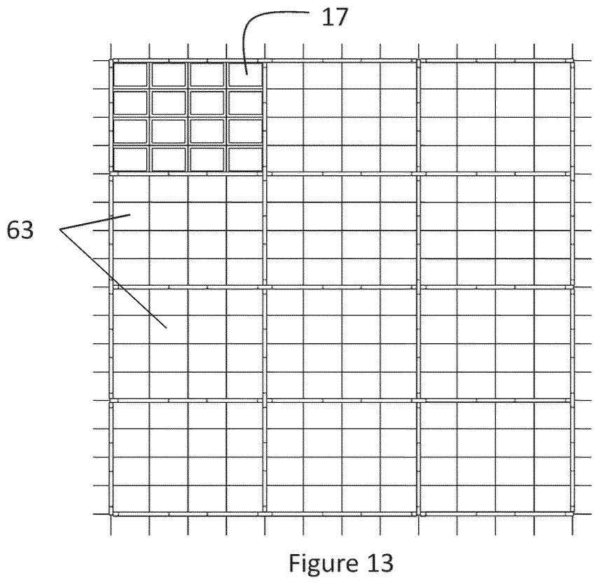

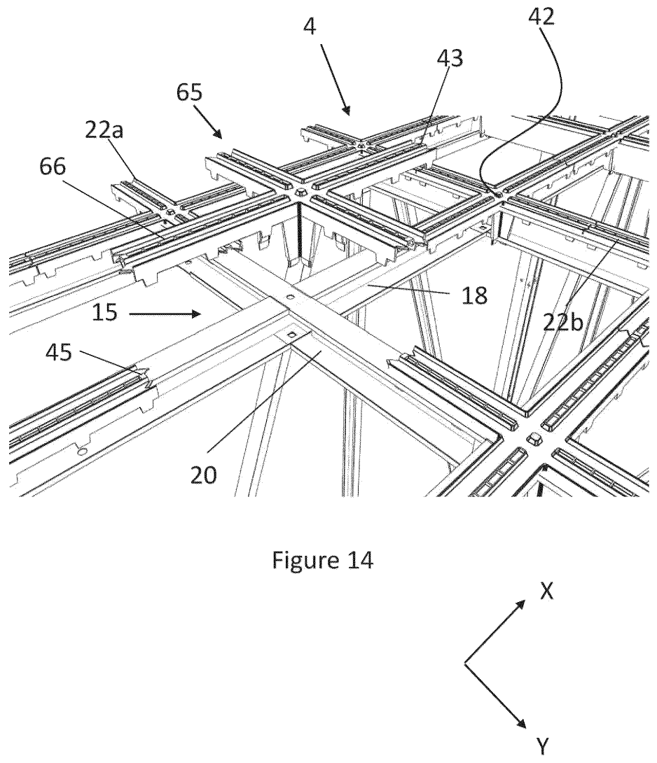

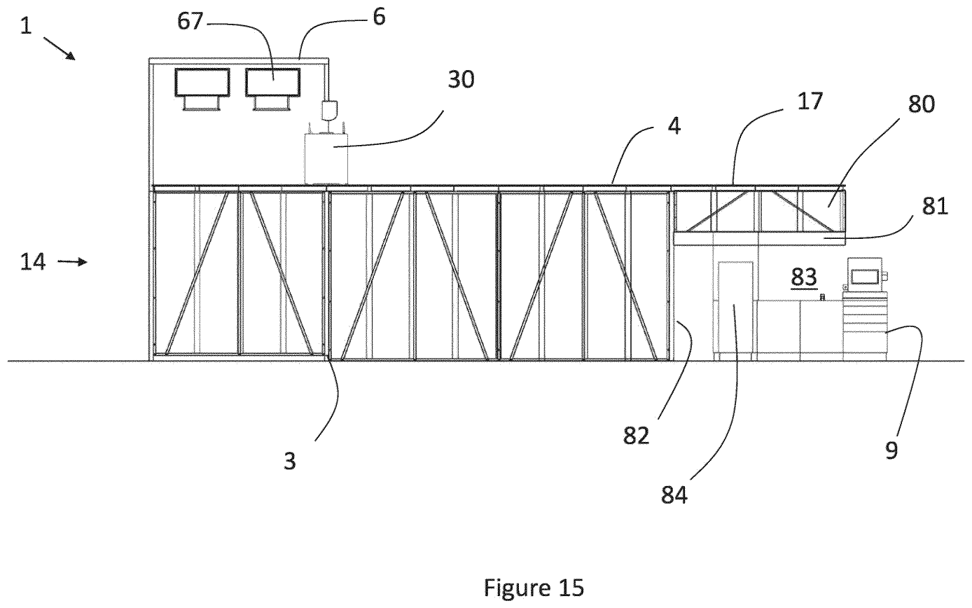

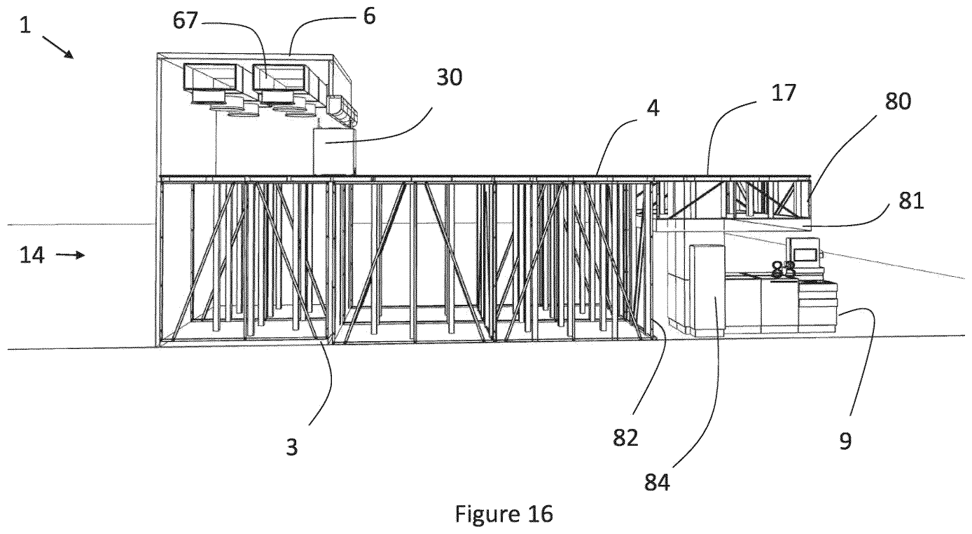

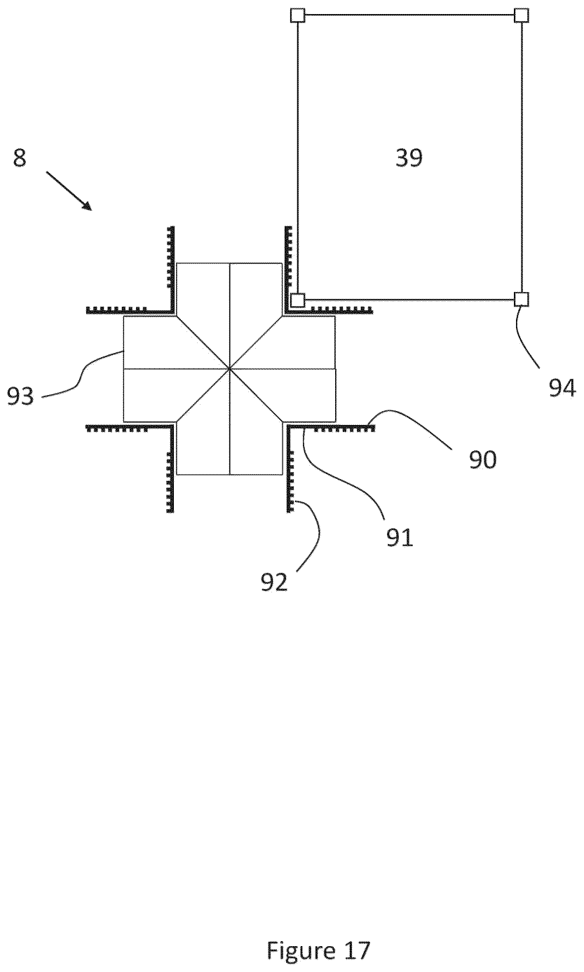

It is against the known features of the storage system such as the grid framework structure and the load handling device described above with reference to FIGS. 1 to 5, that the present invention has been devised. FIG. 6 illustrates a multi-temperature storage system 1 according to an embodiment of the present invention. The multi-temperature storage system 1 comprises a grid framework structure 14 comprising a track system 4 comprising a first set of tracks 22a extending in a first direction, and a second set of tracks 22b extending in a second direction. The tracks 22a, 22b of the track system are arranged in a grid pattern comprising a plurality of grid cells 17. The track system 4 is supported on top of a supporting framework structure 3. The supporting framework structure 3 creates a storage space underneath the track system 4, comprising a plurality of storage columns 5. Each storage column 5 is arranged to store a stack of storage containers (not shown).

In the particular embodiment of the present invention shown in FIG. 6, the support framework structure comprises a plurality of prefabricated modular panels arranged in a grid pattern, the detail of which is described briefly below and fully in the PCT application, WO2022034195A1, in the name of Ocado Innovation Ltd, and incorporated herein by reference. This grid framework structure described in WO2022034195A1 addresses the problem of time and cost to assemble by providing a supporting framework structure comprising a plurality of prefabricated modular panels arranged in a three dimensional grid pattern to define a plurality of grid cells. Each of the grid cells of the supporting framework structure is sized to support two or more grid cells of the grid structure. The grid framework structure is formed from fewer structural components yet still maintains the same structural integrity as the typical “stick-built” grid framework structure described above, and is much faster and cheaper to build.

FIG. 11 is an example of the supporting framework structure 3 for supporting the track support structure 2 and track system 4. The supporting framework structure 3 is fabricated from an assembly of prefabricated modular panels 60 to create one or more storage spaces 61. Each of the one or more storage spaces 61 is sized to store a plurality of stacks 12 of storage containers 10 commonly known as storage bins (not shown).

Prefabrication of the modular panels involves assembling and fixing separate components of the supporting framework structure 3 together prior to erecting the supporting framework structure 3. There are numerous ways in which this can be achieved. In one example, prefabrication of the modular panels can be achieved through additive manufacturing, e.g. 3D printing. The 3D printed modular panels can then be assembled into the supporting framework structure. In some examples, prefabrication of the modular panels involves prefabricating a sub-group of the plurality of uprights together to form prefabricated braced frames that would facilitate ease of assembly of the supporting framework structure. Further detail of the assembly of the prefabricated braced frames is discussed below.

The same principle of prefabrication can be applied to the grid framework structure 14 and the track system for guiding the robotic load handling devices 30 on the grid framework structure 14. Various lightweight materials can be used in the prefabrication of modular panels. These include but are not limited to metal, plastic, or a fibre-reinforced composite material. One of the key features of the prefabricated modular panels is that fewer components are needed to assemble the supporting framework structure and the prefabricated modular panels can be flat packed to facilitate ease of transport. The other key feature of the prefabricated modular panels making up the supporting framework structure is that they are planar in the sense that each of the prefabricated modular panels lies in its respective plane. The planar configuration of the prefabricated modular panels enables a plurality of prefabricated modular panels to be arranged in a grid pattern comprising a plurality of grid cells or grid spaces. For example, a plurality of prefabricated modular panels comprises a first set of parallel prefabricated modular panels extending in a first direction and a second set of parallel prefabricated modular panels extending in the second direction, the second direction being substantially perpendicular to the first direction.

In the example illustrated in FIG. 11, the prefabricated modular panels 60 forming the supporting framework structure 3 are each configured as prefabricated braced frames or panels comprising a plurality of uprights braced together by one or more bracing members extending between the plurality of uprights. Not all of the prefabricated modular panels in the supporting framework structure can be prefabricated braced frames as shown in FIG. 11, and the prefabricated modular panels can be a combination of one or more of the prefabricated braced frames and one or more of another type of prefabricated modular panel, e.g. 3D printed panel. However, in the particular embodiment of the present invention shown in FIG. 11, each of the prefabricated modular panels 60 is a prefabricated braced frame comprising a plurality of upright members braced together by one or more bracing members. The bracing allows a sub-group of uprights to be assembled together prior to being assembled in the supporting framework structure.

To enable the prefabricated braced frames to be flat packed to facilitate transport, the plurality of uprights of each of the prefabricated braced frames extend in a common plane and are secured together by one or more bracing members. The one or more bracing members connecting the plurality of uprights lie in the same plane as the plurality of the uprights such that each of the prefabricated braced frames is planar. Each upright of the plurality of uprights can be a solid support beam of I-shape or H-shape comprising opposing beam flanges to enable the uprights to be braced together by the one or more bracing members.

As the plurality of prefabricated braced frames in the supporting framework structure 3 are arranged in a grid pattern comprising a plurality of grid cells 63 as demonstrated in FIGS. 11 and 12, the grid cells 63 of the supporting framework structure function as storage columns for storing one or more stacks of storage containers or bins. To reduce the number of components of the supporting framework structure and thus increase the speed in which the supporting framework structure can be erected, the grid cells 63 of the supporting framework structure are sized so as to support a plurality of grid cells 17 of the grid 15. In other words, the ratio of the number of grid cells 17 of the grid 15 per grid cell 63 of the supporting framework structure 3 is X: 1, where X is any integer greater than one, i.e. each of the grid cells 63 of the supporting framework structure 3 is sized to support a subset of the plurality of grid cells 17 of the grid 15, said subset comprising two or more grid cells 17 of the grid 15.

FIG. 12 is a perspective view of the grid framework structure 14 comprising the supporting structure 3 of FIG. 11, supporting a grid 15 on top of the supporting structure 3.

In the example shown in FIG. 12 and in the top plan view of the grid framework structure in FIG. 13, the plurality of the grid cells 63 of the supporting framework structure 3 are broken down such that there are twelve grid cells 17 of the grid 15 per grid cell 63 of the supporting framework structure 3. Thus, each of the grid cells 63 of the supporting framework structure 3 provides a storage space for the storage of twelve stacks of storage containers. The plurality of grid cells 63 of the supporting framework structure 3 shown in FIGS. 12 and 13 generates multiple storage spaces for the storage of a plurality of stacks of storage containers within each of the storage spaces of the supporting framework structure.

The supporting framework structure 3 shown in FIGS. 11, 12, and 13 is not just limited to the prefabricated braced frames and can apply to any prefabricated modular panels including but not limited to 3D printed prefabricated modular panels, i.e. first and second subsets of prefabricated modular panels are arranged such that the first and second subsets of prefabricated modular panels in the first and second direction are offset by at least one grid cell.

The supporting framework structure is not limited to the supporting framework structure discussed in WO2022034195A1 and can include other types of supporting grid framework structures. For example, the supporting framework structure can be a “stick-built” design comprising upright members 16 supporting horizontal grid members 18, 20 as described earlier.

The movement of robotic load handling devices 30 are guided on the supporting framework structure by the track system 4.

To provide an uninterrupted track surface on the grid structure, the track system 4 comprises a plurality of interconnected modular track sections 65, each track section 65 of the plurality of track sections being formed as a single unitary body. Adjacent track sections are arranged to meet between the nodes 42 of the grid 15, i.e. meet at a point 43 between the crossings of the tracks (see FIG. 14). The single piece moulding allows a one to one relationship to exist between each track section 65 and each of the nodes 42 of the grid structure in the sense that only a single track section occupies a single node of the grid structure rather than at least two track sections as found in prior art grid structure described above. In the particular embodiment shown in FIG. 14, each track section 65 has connecting portions or elements 66 that extend in the directions of the underlying (grid members) track supports 18, 20 so as to provide a track surface that extends in the first direction and the second direction, i.e. each track section 65 is cross shaped having connecting portions or elements 154 extending in transverse directions. For the purpose of explanation of the present invention, the connecting portions or track section elements 66 can be termed ‘branches’ that extend in transverse directions from the nodes 42.

Multiple track sections 65 are mounted to the underlying grid structure or track support 18, 20 to provide a continuous uninterrupted track surface between adjacent track sections for one or more load handling devices to move on the grid structure 15. The distal ends 45 of the connecting portions or elements (branches) 66 of adjacent track sections meet substantially half way or mid-point between neighbouring nodes42 of the grid structure 15, i.e. meet or join at the mid-point between adjacent track crossings. This has the advantage of reducing the number of differently shaped track sections necessary to assemble the track for a substantial portion of the grid structure, i.e. removes the “jigsaw” effect where a track section has a specific place in the track, and thereby reduces the time to assemble the track on the grid structure. In addition, the tooling costs to manufacture the track sections would be greatly reduced since a smaller number of tooling designs would be necessary to mould the track section of the present invention in comparison to prior art tracks.

As described above, the storage containers 10 when being lifted by the grabber device 39 are guided by the vertical uprights 16 of the grid framework structure. The vertical uprights 16 are arranged in a grid pattern to provide a plurality of storage columns 5 for storage containers 10 to be stored in stacks 12. Traditionally, the vertical uprights 16 have structural, load bearing components as well as to guide the storage containers 10 through the grid cells 17. Since the load bearing capacity of the supporting framework structure 3 is largely be transferred to the prefabricated modular panels 60 which are largely prefabricated braced frames, the storage system 1 may comprise guides 8 extending substantially vertically between the track system 4 and the floor. Thus, the guides 8 are not required to be load-bearing as in a stick-built supporting framework structure 3. Therefore, thinner flexible upright members can be used as guides, since they are not required to be load-bearing.

Flexible guides 8 allow for misalignment of storage containers 10 when being lifted or lowered in a storage column 5. With rigid guides 8, if the storage container 10 becomes misaligned when being lifted or lowered (for example, if the cables 38 lowering the grabber device 39 are of different lengths, or if one of the cables extends further than the others, so that the storage container 10 is not level), the storage container could easily become jammed between the guides 8. With flexible guides 8, the guides have some resilience so can deflect to allow for misalignment of the storage container 10 without jamming. Therefore the likelihood of a storage container 10 becoming jammed due to misalignment within its storage column 5 is reduced. The guides 8 are arranged in a grid pattern at some or all of the corners of the storage columns 5. The stacks 12 of storage containers 10 in the storage columns 5 are therefore arranged between the guides 8. The guides 8 are for guiding a storage container 10 as the storage container 10 is lifted from its position in the stack upwards through a grid cell 17 into the container receiving space 41 of the load handling device 30. Similarly, the guides guide a storage container 10 as it is lowered from the container receiving space 41 of the load handling device 30 through a grid cell 17 down to its position in the stack 12.

In some examples, the guides 8 comprises two perpendicular bin guiding plates 90 extending between the track system 4 and the floor for accommodating a corner of a storage container 10. The bin guiding plates 90 engage with a corner of a storage container 10 and help to guide the storage container 10 in a vertical direction when it is being lifted or lowered by a load handling device 30.

FIG. 17 illustrates a guide 8 where part of the bin guiding plates 90 is formed of steel comprising a pattern or texture formed by continuous cold rolling of the steel. Adding the pattern work hardens the material, improving the material properties. An example of such a material is ultraSTEEL®. The use of this material helps to improve the material properties of the guide 8, for example increasing the modulus or stiffness of the guide 8 so that less material can be used, therefore saving weight and cost. The pattern or texture can be any suitable pattern or texture, for example a regular pattern of dimples or indentations. The effect of the pattern or texture is to reduce the thickness of material required to achieve the required structural strength, therefore reducing material use. This increases the stiffness and bending resistance of the guides with no increase in mass of the material used.

If the entire surface of the guide 8 were formed of ultraSTEEL® or another textured material, any parts of the pattern protruding from the surface could impede the smooth running of the storage container 10 along the guide 8. To solve this problem, in some cases the perpendicular bin guiding plates comprise a substantially smooth running surface 91 for engaging with the storage container 10 and/or the grabber device 8, and an outer surface 92 formed from textured or patterned material. Thus the part 91 of the bin guiding plates that is in direct contact with the storage container 10 and/or the grabber device 39 is substantially smooth, and does not impede the movement of the storage container 10 and/or grabber device 39 up and down the guides 8, while the part 92 of the bin guiding plates that is not in direct contact with the storage container 10 and/or the grabber device 39 is textured or patterned, thus the guide 8 enjoys the benefits of increased strength.

In the example illustrated in FIG. 17, the guide 8 comprises four pairs of bin guiding plates 90. The bin guiding plates 90 are attached to one or more frames 93 that hold the four pairs of bin guiding plates 90 together to form the guide 8. The guide 8 can therefore guide four storage containers 10 at each of the four corners of the guide 8, each storage container 10 being guided by one pair of the four pairs of bin guiding plates 90.

The grabber device 39 may be provided with corner members 94 that reinforce the corners (vertical edges) of the grabber device, and stand proud of the grabber device, in order to ensure smooth running of the grabber device up and down the guides 8. In the specific example illustrated in FIG. 17, the corner members 94 are in contact with the smooth running surface 91 of the guides 8, and ensure that the guides 8 do not contact the body of the grabber device 39 itself, only the corner members 94.The robotic load handling devices 30 operable on the track system 4 are able to lift one or more containers 10 through a grid cell 17 from a stack 12 in a storage column 5. To store items and goods at different temperatures, a portion of the storage system 1 is contained within an enclosure 6. The enclosure 6 provides a volume within the enclosure 6 that can be temperature controlled.

The temperature within the enclosure 6 is controlled by a temperature control system 50, which comprises a temperature control unit 52. The temperature within the enclosure 6 can be controlled to be higher or lower than the temperature outside the enclosure 6. In some examples, the temperature control system 50 is a heating system and the temperature control unit 52 is a heating unit, and the temperature within the enclosure 6 can be controlled to be higher than the temperature outside the enclosure 6. In other examples, the temperature control system 50 is a chiller system and the temperature control unit 52 is a chiller unit, and the temperature within the enclosure 6 can be controlled to be lower than the temperature outside the enclosure 6.

For example, the enclosure 6 can warmed by a heating system 50. The heating system 50 comprises an inlet 51 for drawing air from the enclosure 6, a heating unit 52 for heating the air, and an outlet 53 for releasing the heated air back into the enclosure 6. The heated air is circulated within the enclosure 6, and heated on every cycle through the heating unit 52, so a constant (warmer) temperature within the enclosure 6 is maintained.

Heating the section of the storage system 1 inside the enclosure 6 could be required if, for example, the storage system is used for growing plants or other living organisms. Different plants or living organisms with the same storage system 1 may have different requirements for different growing conditions. Use of a multi-temperature storage system enables different parts of the storage system to provide different environmental conditions. For example, plants or other living organisms that require a higher temperature for growth could be stored inside the enclosure 6 heated to a higher temperature, and plants or other living organisms that require a lower temperature for growth could be stored outside the enclosure 6 at an ambient temperature.

In another example, the enclosure 6 can cooled by a chiller system 50. The chiller system 50 comprises an inlet 51 for drawing air from the enclosure 6, a chiller unit 52 for cooling the air, and an outlet 53 for releasing the cool air back into the enclosure 6. The cool air is circulated within the enclosure 6, and cooled on every cycle through the chiller unit 52, so a constant (cooler) temperature within the enclosure 6 is maintained.

FIG. 7 is a flowchart which schematically illustrates the flow of air in the enclosure 6. Air within the enclosure 6 is circulated: air is drawn from within the body of the enclosure 6 into an inlet 51, then directed into the temperature control unit 52. The air is then heated or cooled by the temperature control unit 52, and then released via the outlet 53 back into the enclosure 6. Ducting or tubing 58 transfers the heated or cooled air from the temperature control unit to the outlet. One or more fans 59 (not shown) are used to draw the air through the temperature control unit 52 via the inlet 51 and force the heated or cooled air along the ducting 58 to the outlet 53.

The following description refers to an embodiment where the temperature control system 50 is a chiller system, the temperature control unit 52 is a chiller unit, and the temperature within the enclosure 6 is controlled to a chilled temperature lower than the temperature outside the enclosure 6. This example is not intended to be limiting, and in other examples the temperature inside the enclosure 6 may be higher than the temperature outside the enclosure 6.

In the particular embodiment shown in FIG. 8, the one or more ducts 58 extend through the interior space of the enclosure 6 via an aperture in the enclosure 6. To circulate chilled air in the enclosure 6, the outlet 53 can comprise one or more diffusers 67 that help to diffuse the chilled air into the enclosure 6. The outlet 53 shown in FIG. 8 is positioned above the portion of the grid framework structure 14 housed within the enclosure 6 such that the chilled air enters the grid framework structure 14 from above and percolates through the plurality of storage containers 10 stored in stacks 12 in the grid framework structure 14, chilling the contents of the storage containers 10. The air is subsequently drawn through the inlet 51 towards the bottom or base of the enclosure 6 below the track system 4, and back through the chiller unit 52 so that the air flows in a continuous cycle from the inlet 51 into the outlet 53 as the chilled air maintains the temperature within the enclosure 6 at a controlled temperature, i.e. chilled temperature (4° C. to 8° C.). Although this particular embodiment is described with reference to cooled air, other temperature-controlled fluids (heated or cooled) are also applicable in the current invention.

Whilst the inlet 51 and the outlet 53 of the chiller system 50 are arranged such that air flows in a downward direction within the enclosure 6, the reverse is possible where the outlet 53 is towards the bottom of the enclosure 6 below the track system 4 and the inlet 51 is towards the top of the enclosure 6 above the track system 4 such that chilled air flows from the bottom of the enclosure 6 and travels in an upward direction towards the inlet 51 above the track system 4.

Whilst the particular example describes the temperature within the enclosure to be controlled to provide storage for chilled goods, i.e. 4° C. to 8° C., the present invention is not limited to the storage of chilled goods within the enclosure and can be other temperature controlled ranges, e.g. frozen temperature range (−18° C. to −22° C.) or even elevated temperatures above ambient temperature. The key point here is that the enclosure 6 provides a temperature controlled environment for the storage of temperature sensitive items or goods.

The enclosure 6 is cooled so that the temperature inside the enclosure 6 is lower than the temperature outside the enclosure 6. The temperature outside of the enclosure 6 can be at ambient temperature or even at a temperature lower than the temperature inside of the enclosure. The enclosure 6 is thermally insulated to reduce the transfer of heat through the walls of the enclosure 6 such that the temperature inside the enclosure 6 is different to the temperature outside of the enclosure 6. The thermal insulation can include various physical insulation boards including but is not limited to thermal insulation boards, thermal blanket, etc. The thermal insulation extends from below the track system 4 to an area above the track system 4 so as to enable one or more robotic load handling devices 30 operable on the track system 4 to move on the tracks 22 within the enclosure 6. Further detail of the types of insulation used to thermally insulate the enclosure 6 according to an embodiment of the present invention is discussed below.

To allow one or more robotic load handling devices 30 to enter and exit the enclosure 6 on the track system 4, the enclosure 6 comprises an opening 7 above the track system 4 such that the track system 4 extends continuously through the opening 7. To limit or prevent the chilled air in the enclosure 6 from escaping through the opening 7 of the enclosure 6 and/or heat from entering the enclosure 6 via the opening 7, the opening 7 comprises an air curtain 55 across the opening 7 to contain the cooled air inside the enclosure 6 while permitting load handling devices 30 to pass through the air curtain 55 into and out of the enclosure 6. The air curtain 55 is produced by one or more air curtain units 54, which take air from within the enclosure 6, and emit a constant stream of air which travels downwards from the air curtain unit 54 to the track system 4.

An air curtain (also known as an air door or invisible door) is a controlled stream of air across an opening. The stream of air creates an air seal which separates different environments while allowing an uninterrupted flow of traffic and unobstructed vision through the opening.

Operation of the air curtain unit 54 is described below. Once powered on, air is brought into the air curtain unit 54 through an intake 56. The air is then accelerated by a fan. This fast-moving air is directed into a plenum, which allows for an even distribution of air along the length of an elongated discharge nozzle 57. Airfoil-shaped vanes or baffles 68 in the nozzle 57 create a uniform air stream with minimal turbulence. The air discharged through the nozzle 57 creates a jet stream to the floor.

The air curtain 55 across the opening 7 can be envisaged as an invisible thermal insulation barrier between the inside and outside of the enclosure 6. As the temperature of the air curtain 55 is determined by the temperature of the air within the enclosure 6, it is important that the stream of air from the air curtain unit 54 does not impinge on any parts of the grid framework structure 14 outside of the enclosure 6, for fear of spoiling goods or items stored in storage containers 10 outside the enclosure 6. To re-direct the air stream from the air curtain 55 towards the enclosure 6, the airfoil vanes or baffles 68 can be orientated such that the jet of air from the air curtain unit 54 flows towards inside of the enclosure 6. As a result, the air curtain 55 adopts a downwardly inclined orientation from the air curtain unit 54 towards the inside of the enclosure 6. The air curtain unit 54 has an intake 56 that extends into the enclosure 6 and an outlet adjacent the opening 7 of the enclosure 6 such that chilled air from inside the enclosure 6 is recirculated through the air curtain unit 54 and back into the enclosure 6.

FIG. 9 illustrates a load handling device 30 passing through an air curtain 55 produced by an air curtain unit 54. The load handling device is able to pass directly through the air curtain 55 without any obstruction or any need to alter the course or reduce the speed of the load handling device 30, so the load handling device 30 can quickly and efficiently move along the track system 4 through the air curtain 55 into or out of the enclosure 6. When in the process of passing through the air curtain 55, the stream of air is broken by the load handling device 30. The air curtain effectively forms a seal around the load handling device 30 while the load handling device 30 passes through the curtain 55. FIG. 10 illustrates an air curtain unit 54, with air intake 56 and elongated nozzle 57, producing an air curtain 55.

The number of robotic load handling devices 30 that can travel simultaneously through the enclosure 6 and thus, the efficiency by which multiple storage containers 10 can be retrieved from the area within the enclosure 6 is very much dependent on the size and/or width of the opening 7 of the enclosure 6. For example, the opening 7 can extend across multiple grid cells 17 allowing multiple robotic load handling devices 30 operable on the track system 4 to retrieve multiple storage containers 10 stored in the enclosure 6.

In the particular embodiment shown in FIG. 8, the opening 7 extends across the width of the track system 4 allowing multiple robotic load handling devices 30 to travel between the inside and outside of the enclosure 6. To provide an air curtain 5 that extends across multiple grid cells 17, the air curtain 55 is provided by a plurality of air curtain units 54 arranged side-by-side, each of the plurality of air curtain units 54 providing at least a portion of the air curtain 55 that extends across the opening 7 of the enclosure 6. To provide a continuous air curtain 55 that extends across the opening 7 of the enclosure 6, preferably, the edges of adjacent curtains overlap.

### Enclosure and Insulation

FIG. 8 illustrates the inside of the enclosure 6. The portion of the multi-temperature storage system 1 inside the enclosure 6 is divided into a lower portion 70 below the track system 4, and an upper portion 71 above the track system 4. Load handling devices 30 operate in the upper portion 71 on the track system 4. The lower portion 70 is occupied by stacks 12 of storage containers 10.

The track system 4 is supported by the supporting framework structure 3. The supporting framework structure 3 can be integral with the supporting framework structure 3 supporting the track system 4 outside the enclosure 6, or alternatively, separate supporting framework structures 3 can be provided inside and outside the enclosure 6. The track system 4 extends over the supporting framework structure(s) 3 both inside and outside the enclosure 6, through the opening 7 in the enclosure 6, so that load handling devices 30 can freely move into and out of the enclosure 6 on the track system 4, i.e. the track system 4 extends from inside the enclosure 6 to outside of the enclosure 6.

Walls extend above the track system 4 to the roof to form the enclosure 6 having an opening 7 above the track system 4. The lower portion 70 of the enclosure 6 encloses a portion of the storage system, i.e. a plurality of storage columns 5 are enclosed by walls along all four sides of the lower portion 70 of the enclosure 6. The plurality of storage columns 5 enclosed by the enclosure 6 are a subset of the total number of storage columns in the grid framework structure. The walls enclosing the lower portion 70 extend upwards above the track system 4 in order to enclose the upper portion 71 of the enclosure 6. The upper portion 71 of the enclosure 6 has an opening 7 at one side of the enclosure 6 for a load handling device 30 to move in and out of the enclosure 6.

The upper portion 71 of the enclosure 6 is formed by the walls of the enclosure 6 extending above the track system 4. The walls of the enclosure 6 extend from the floor of the building housing the storage system to the roof of the enclosure 6. One of the walls in the upper portion 71 is absent, to form the opening 7. In the illustrated example, the whole of one wall above the track system 4 is absent, but in other examples a part of one wall can be absent, or a part or a whole of more than one wall above the track system 4. The walls forming the enclosure 6 fully enclose the portion of the storage system 1 except for the opening 7, through which load handling devices 30 can freely move into and out of the enclosure 6 on the track system 4.

The enclosure 6 illustrated in FIG. 8 is thermally insulating. The air curtain 55 extends across the opening 7 of the enclosure 6 in order to maintain the temperature difference between the inside and the outside of the enclosure 6.

One or more external walls of the supporting framework structure 3 in the lower portion 70 can be cladded with thermal insulating solid walled panels 72 so as to encase the interior space of the supporting framework structure 3. In some examples, the thermal insulating solid wall panels 72 form part of the enclosure 6. The thermal insulating solid walled panels 72 provide a thermal barrier to prevent escape of heat from the interior space of the supporting framework structure 3 in the lower portion 70 of the enclosure. In the case where the contents of the storage containers 10 are temperature sensitive, such as grocery items, thermal insulating solid walled panels 72 encasing the exterior walls of the supporting framework structure 3 have the advantage of reducing the transfer of heat between the interior of the lower portion 70 of the enclosure 6 and the exterior. For example, the interior space of the enclosure 6 can be a chilled zone operating within the temperature range between substantially 0° C. to substantially 5° C., or a frozen zone operating within the temperature range between substantially −25° C. to substantially 0° C., preferably between substantially −21° C. to substantially −18° C.

In order to maintain the temperature difference between the inside and the outside of the enclosure 6, all four sides of the supporting structure 3 in the lower portion 70 of the enclosure can be clad with thermal insulating solid walled panels 72.

Additionally, the floor of the enclosure 6 can be insulated to reduce heat transfer between the enclosure 6 and the ground. Any suitable kind of thermal barrier can be used, for example thermally insulating floor tiles or a thermally insulating carpet or thermally insulating panels.

In cases where the supporting framework structure 3 in the lower portion 70 of the enclosure 6 is formed from prefabricated modular panels 60, one or more of the thermal insulating solid walled panels 72 may comprise a structural insulation panel. Structural insulation panels are load-bearing as well as having insulating properties. Structural insulation panels may comprise a thermal insulation core sandwiched between at least two layers of structural board. The structural insulation panels, since they are load-bearing, can form part of the supporting structure 3 rather than being cladding on the outside with no load-bearing function. This has the advantage of reducing cost, complexity, and required time to construct the storage system, since the structural insulation panels are one part performing two functions (providing structural support and insulation).

In the example illustrated in FIG. 8, the enclosure is substantially rectangular, with two long sides and two short sides. However, it is not necessary that the enclosure is substantially rectangular, and other shapes of the enclosure are perfectly permissible in the present invention. The lower portion 70 of the enclosure comprises a supporting structure 3 formed from prefabricated modular panels 60 and structural insulation panels. The prefabricated modular panels 60 all extend in the same direction (the first direction) between the two long sides of the enclosure 6, and parallel to the two short dies of the enclosure 6. The majority of the structural insulation panels extend in the second direction, perpendicular to the first direction, and parallel to the long sides of the enclosure 6. The structural insulation panels form the two long sides of the enclosure 6, and the prefabricated modular panels 60 extend between the structural insulation panels along the two long sides of the enclosure 6. Additional structural insulation panels extend in the first direction to form the two short sides of the enclosure 6. Thus, structural insulation panels extend along all four sides of the enclosure 6, enclosing the space within the enclosure and helping to maintain the temperature difference between the inside and the outside of the enclosure 6.

In the specific example illustrated in FIG. 8, the inlet 51 of the chiller system is located below the track system 4 in the lower portion 70 of the enclosure. The inlet 51 extends through the structural insulation panels from the enclosure 6 into the chiller unit 52 located outside the enclosure 6. The chilled air from the chiller unit 52 is directed into the enclosure 6 via the ducting 58. The ducting 58 comprises a substantially vertical portion located outside the enclosure, and a substantially horizontal portion extending through the thermally insulating blanket into the enclosure 6.

The upper portion 71 of the enclosure is provided with a thermally insulating cover 73. The thermally insulating cover 73 can take any suitable form and be made of any suitable insulating material. For example, the thermally insulating cover can comprise thermally insulating solid panels or a thermally insulating blanket. In the example illustrated in FIG. 8, the thermally insulating cover 73 in the upper portion 71 of the enclosure 6 comprises a top wall 74 and four downwardly extending sidewalls 75 on the four sides of the track system 4. The downwardly extending sidewall on the side of the upper portion adjacent to the portion of the storage system 1 outside the enclosure 6 comprises the opening 7.

In some examples, the thermally insulating cover 73 comprises a thermally insulating blanket. Thermally insulating blankets, being flexible, have the advantage of being easily adaptable to different sizes and shapes of storage system, and do not require a bespoke design of the thermally insulting cover for every individual storage system.

The thermally insulating blanket can be attached to the roof of the building, or to a separate structure, by any suitable attachment means. For example, one or more struts can be mounted to the roof of the building. The struts may be unistruts, which comprise one or more threaded holes, into which one or more drop shafts can be screwed. A second unistrut is attached underneath, with the thermally insulating blanket clamped between the two struts. Diffusers 67 mounted to the ceiling can pass through one or more apertures in the thermally insulating blanket, in order to permit the diffusers 67 to access the inside of the enclosure 6 while providing a thermal seal around the diffusers 67.

As an alternative or addition to the thermally insulating cover 73 comprising one or more thermally insulating blankets, the ducting 58 that is used to circulate chilled air from the chiller unit 52 may be thermally insulated and form part of the thermally insulating cover 73. Thermal insulation can be provided around the outside of the ducting 58 to form thermally insulated ducting. Thermally insulated ducting can form part or all of the top wall 74 and/or the downwardly extending sidewalls 75 of the thermally insulating cover 73. This arrangement has the advantage of ease of assembly, and reduced cost and complexity. The thermally insulated ducting fulfils two functions: providing a path for recirculating fluid in the chiller system 50, and insulating the enclosure 6 to maintain the temperature difference between the inside and the outside of the enclosure 6. In some examples, thermally insulated ducting can be used in combination with thermally insulating blankets to form the thermally insulating cover 73.

In order to fulfill customer orders, FIG. 15 and FIG. 16 schematically illustrate the multi-temperature storage system 1 with an inventory handling station 9 arranged below the track system 4. Storage containers are transported to and from the inventory handling station 9 by means of a port column 84. The port column 84 is a storage column 5 that is not used for storing containers 10 and comprises a location where a load handling device 30 can drop off and/or pick up storage containers or bins 10 to and from the inventory handling station 9. The port column 84 corresponds to the grid cell 17 where storage containers 10 are dropped off or picked up by load handling devices 30. Depending on whether the port is located for drop off or pick up of a storage container 10, the grid column where the port is located may be referred to as a “delivery column” located at a drop off port and a “retrieval column” located at a pick up port.

The inventory handling station 9 is located below the track system 4. In order to create a space for the inventory handling station 9, the storage system 1 comprises a support platform 81 raised above the ground by a plurality of legs 82 so as to define an area 83 under the support platform 81.

In the example illustrated in FIG. 15 and FIG. 16, this area 83 below the support platform 81 is used for accommodating the inventory handling station 9. In other examples, various other stations and service areas can be accommodated within the space 83. For example, the space 83 can accommodate charge stations for charging rechargeable power sources powering the load handling devices 30 on the track system 4, service stations to carry out routine maintenance of the load handling devices 30, or other stations.

To increase the storage capacity of the grid framework structure 14, the storage system 1 further comprises a second supporting framework structure 80 mounted on top of and supported by the support platform 81. The support platform 81 may be supported by a plurality of purlins underneath the support platform 81 to increase the structural rigidity of the support platform 81 to support a plurality of storage containers 10 in multiple stacks 12 on the support platform 81. The second supporting framework structure 80 may be separate from the supporting framework structure 3 in the remainder of the storage system 1, or may be integrated into the same structure. The second supporting framework structure 80 may be a stick-built structure, or a modular structure comprising prefabricated modular panels 60 as described above, or any other suitable supporting structure. The second supporting framework structure 80, like the supporting framework structure 3, is used for storing stacks 12 of storage containers 10.

The track system 4 extends continuously across the supporting framework structure 3 and the second supporting framework structure 80. Thus, load handling devices 30 can travel on the track system 4 over both the supporting framework structure 3 and the second supporting framework structure 80. The shared track system 4 therefore enables load handling devices 30 to transport storage containers 10 in stacks 12 in both the supporting framework structure 3 and the second supporting framework structure 80 to and from the inventory handling station 9.

The support platform 81 performs a similar function to mezzanines in prior art storage systems. Typical mezzanines have the problem of requiring a bespoke design for each site, and being costly and time-consuming to build, because careful matching of dimensional tolerances is required. The support platform 81 has the advantage of being faster to build and easily adaptable to different sizes and layouts of storage systems 1, especially in storage systems 1 where the second supporting structure 80 comprises prefabricated modular panels 60. The support platform 81 can be a modular support platform comprising standard-sized modules, enabling any size of support platform 81 to be selected to suit the available site. Similarly, the support platform 81 can be any required height (the height of the supporting legs 82 can be adjusted). Thus a support platform 81 can easily and quickly be built for any site, without requiring a bespoke design. The support platform 81 is offered up to and abuts the supporting framework structure 3.

In the example illustrated in FIG. 15 and FIG. 16, the second supporting framework structure 80 is a modular structure comprising prefabricated modular panels 60. The advantage of using prefabricated modular panels 60 for the supporting framework structure 80 is that the system is even more modular, because both the second supporting framework structure 80 and the support platform 81 are modular. Bespoke designs are not necessary, and storage systems of any desired size and layout can be assembled quickly and cost-effectively.

The advantage of the multi-temperature storage system 1 for fulfilling customer orders, particularly grocery items, in comparison to storage systems known in the art where temperature sensitive goods are generally fulfilled separately to non-temperature sensitive goods is that different goods can be fulfilled in a single location. In use, when fulfilling a basket of grocery items or goods which comprise both temperature sensitive goods and non-temperature sensitive goods, since the track system 4 is common to both the grid framework structure 14 inside and outside of the enclosure 6, one or more robotic load handling devices 30 operable on the track system 4 can be instructed to retrieve the temperature sensitive items from inside the enclosure 4 and move the storage container 10 to an inventory handling station 9, wherein the items in the storage container 10 can be picked to fulfil part of a customer order. Similarly, one or more robotic load handling devices 30 can be instructed to retrieve a storage container 10 from the non-temperature-sensitive area of the grid framework structure 14 outside of the enclosure 6 and transport the storage container 10 to the inventory handling station 9 for completing the customer's order. To increase the efficiency for fulfilling a plurality of customer orders, the multi-temperature storage system 1 can comprise a plurality of inventory handling stations 9, each of the plurality of inventory handling stations 9 fulfilling different customer orders.

Whilst the particular embodiment describes a single enclosure 6, the present invention is not limited to a single enclosure 6. For example, the multi-temperature storage system 1 according to the present invention can comprise a plurality of enclosures 6, each enclosure 6 of the plurality of enclosures 6 having its own respective opening 7, a chiller system 50 as described above and at least one air curtain unit 54 for generating an air curtain 55 across the respective opening 7 of the enclosure 6. The track system 4 is shared amongst the plurality of enclosures 6 such that a robotic load handling device 30 operable on the track system 4 can enter different enclosures 6 of the plurality of enclosures 6, i.e. the track system 4 continuously extends through the plurality of enclosures 6.

One way to achieve this is by having one or more or more of the plurality of enclosures 6 comprising more than one opening 7, e.g. an entry into the enclosure 6 and an exit for exiting the enclosure 6. In some examples, the entry and the exit can be provided by a single opening 7 of the enclosure 6, and in other examples the entry and exit can be provided by separate openings 7 of the enclosure 6. In cases where the entry and exit are provided by separate openings 7, the openings 7 can be located on the same side of the enclosure 6 or on different sides of the enclosure 7. For example, one or more of the plurality of the enclosures 6 can function as a tunnel so that a robotic load handling device 30 can travel through the enclosure 6 as it makes its way to an inventory handling station 9. Each of the openings 7 of the enclosure 6 can be insulated from the external environment by a respective air curtain 55 as discussed above on entry into the enclosure 6 and another air curtain 55 on exit from the enclosure 6. Each of the plurality of enclosures 6 can provide storage of goods or items at different and/or the same temperature from each other. For example, a first enclosure 6 can be configured to provide storage of goods or items at the chilled temperature range and a second enclosure 6 can be configured to provide storage of goods or items at the frozen temperature range.

1-41. (canceled) Add the following new claims:

42. A multi-temperature storage system comprising:
A) a grid framework structure configured for supporting a robotic load handling device thereupon, said grid framework structure including:
i) a track system including a plurality of tracks arranged in a grid pattern including a plurality of grid cells, and
ii) a supporting framework structure for supporting the track system above the ground to create a storage space with a plurality of storage columns, each storage column being arranged to store a stack of storage containers, such that when a robotic load handling device is operative on the track system one or more containers are lifted through a grid cell from a stack in a storage column,
wherein a portion of the storage system is contained within an enclosure, said enclosure having an opening above the track system for allowing a robotic load handling device to move into and out of the enclosure;
B) a temperature control system including an inlet for drawing a fluid from the enclosure, a temperature control unit for heating or cooling the fluid to a temperature controlled fluid, and an outlet for providing the temperature controlled fluid into the enclosure such that the enclosure has a different temperature than the temperature external of the enclosure; and
C) at least one air curtain unit arranged above the track system, said at least one air curtain unit being arranged to recirculate the temperature controlled fluid from the enclosure to provide an air curtain across the opening of the enclosure so as to substantially contain the temperature controlled fluid within the enclosure and enable a robotic load handling device to move on the track system into and out of the enclosure.

43. The multi-temperature storage system of claim 42, wherein the enclosure is thermally insulating.

44. The multi-temperature storage system of claim 42, wherein the enclosure has a lower portion below the track system and an upper portion above the track system, the lower portion of the enclosure comprising:
thermal insulating solid walled panels.

45. The multi-temperature storage system of claim 43, wherein one or more of the thermal insulating solid walled panels comprises:
a structural insulation panel comprising a thermal insulation core sandwiched between at least two layers of structural board.

46. The multi-temperature storage system of claim 43, wherein the upper portion of the enclosure comprises:
a thermally insulating cover having a top wall and downwardly extending sidewalls, optionally wherein at least one of the downwardly extending sidewalls includes the opening.

47. The multi-temperature storage system of claim 41, wherein the supporting framework structure comprises:
a plurality of prefabricated modular panels, said prefabricated modular panels being arranged in a three dimensional grid pattern including a first set of parallel prefabricated modular panels extending in the first direction and a second set of parallel prefabricated modular panels extending in the second direction to define a plurality of grid cells.

48. The multi-temperature storage system of claim 47, wherein each of the grid cells of the supporting framework structure is sized to support a subset of the plurality of grid cells of the track system, said subset including two or more grid cells of the track system.

49. The multi-temperature storage system of claim 47, wherein at least one of the plurality of prefabricated modular panels comprises:
at least one of the thermal insulating solid walled panels.

50. The multi-temperature storage system of claim 42, wherein the grid framework structure comprises:
a track support structure lying in a horizontal plane and being supported by the supporting framework structure, said track support structure including a first set of parallel track support members extending in a first direction and a second set of parallel track support members extending in a second direction, the second direction being substantially perpendicular to the first direction such that the first and second set of parallel track support members are arranged in a grid pattern comprising a plurality of grid cells or grid spaces; and
wherein the track system is mounted to the track support structure such that the grid cells of the track system correspond to the grid cells of the track support structure.

51. The multi-temperature storage system of claim 50, wherein the track support structure comprises:
a plurality of prefabricated modular sub-track support structures that are assembled together to form the track support structure, each of the plurality of prefabricated modular sub-track support structures including comprising two or more grid cells.

52. The multi-temperature storage system of claim 51, wherein the track system comprises:
a plurality of interconnected modular track sections, each track section of the plurality of interconnected modular track sections comprising substantially perpendicular elements so as to provide a track surface extending in the first direction and the second direction; and optionally, wherein the plurality of track sections are assembled in the track system such that adjacent modular track sections in the track system meet between the areas of the grid framework structure where the first and second sets of track support members intersect or converge in the grid pattern.

53. The multi-temperature storage system of claim 42, comprising:
a plurality of guides extending substantially vertically between the track system and the floor, the plurality of guides being arranged in a pattern for accommodating a plurality of stacks of storage containers between the plurality of guides and to guide the plurality of storage containers through a grid cell.

54. The multi-temperature storage system of claim 53, wherein the plurality of guides are configured and arranged for guiding one or more storage containers in a stack along a pair of diagonally opposing corners of the one or more storage containers.

55. The multi-temperature storage system of claim 53, wherein each guide of the plurality of guides comprises:
two perpendicular bin guiding plates extending between the track system and the floor for accommodating a corner of a storage container.

56. The multi-temperature storage system of claim 55, wherein each guide of the plurality of guides comprises:
ultraSTEEL®.

57. The multi-temperature storage system of claim 55, wherein at least a portion of the two perpendicular bin guiding plates is configured with texture of a continuous cold rolled pattern in the two perpendicular bin guiding plates.

58. The multi-temperature storage system of claim 57, wherein the texture comprises:
dimples or indentations.

59. The multi-temperature storage system of claim 55, wherein each guide of the plurality of guides comprises:
a running surface for engaging with a grabber device of the robotic load handling device, and wherein the running surface is substantially smooth.

60. The multi-temperature storage system of claim 42, comprising:
at least one inventory handling station arranged below the track system; and
wherein one or more of the grid cells of the track system defines a port for delivering and picking up a storage container to and from the inventory handling station.

61. The multi-temperature storage system of claim 60, comprising:
a second supporting framework structure and a support platform for supporting the second supporting framework structure, said support platform being raised above the ground by a plurality of legs so as to define an area under the support platform for accommodating the inventory handling station; and
optionally, wherein the second supporting framework structure is arranged below the track system such that the track system extends continuously across the supporting framework structure and the second supporting framework structure.
